(19) United States
(12) Patent Application Publication
(10) Pub. No.: US 2025/0346452 A1
(43) Pub. Date: Nov. 13, 2025

(54) ELEVATOR MONITORING DEVICE, ELEVATOR MONITORING METHOD, AND RECORDING MEDIUM

(71) Applicants: MITSUBISHI ELECTRIC BUILDING SOLUTIONS CORPORATION, Tokyo (JP); Mitsubishi Electric Corporation, Tokyo (JP)

(72) Inventors: Kakeru YOKOYAMA, Tokyo (JP); Daisuke NAKAZAWA, Tokyo (JP); Seiji WATANABE, Tokyo (JP); Ayaka MIZUTANI, Tokyo (JP); Yoshiko ONO, Tokyo (JP); Sunao FUJIWARA, Tokyo (JP); Junya YASUTOMI, Tokyo (JP)

(73) Assignees: MITSUBISHI ELECTRIC BUILDING SOLUTIONS CORPORATION, Tokyo (JP); Mitsubishi Electric Corporation, Tokyo (JP)

(21) Appl. No.: 19/196,033

(22) Filed: May 1, 2025

(30) Foreign Application Priority Data
May 7, 2024 (JP) 2024-075215

(51) Int. Cl. B66B 5/00; B66B 7/12

(52) U.S. Cl. CPC B66B 5/0025; B66B 7/1215

(57) ABSTRACT

In an elevator monitoring device, a wear prediction unit calculates a wear amount prediction value through use of a wear prediction expression which uses, as inputs, a tension of a car-side portion and a tension of a counterweight-side portion in each of a plurality of ropes suspending a car and a counterweight, a slippage amount of each of the plurality of ropes, and material hardness of a sheave. The wear amount prediction value is a prediction value of a future wear amount that occurs in a set period in each of a plurality of sheave grooves.

### CROSS-REFERENCE TO RELATED APPLICATION

The present application claims the benefit of priority to Japanese Patent Application No. 2024-075215, filed May 7, 2024, which is incorporated herein by reference in its entirety.

### BACKGROUND OF THE INVENTION

### 1. Field of the Invention

This disclosure relates to an elevator monitoring device, an elevator monitoring method, and a recording medium.

### 2. Description of the Related Art

A related-art wear amount measurement device for an elevator calculates an estimation value of a wear amount of a sheave groove from a rotation amount of a sheave that has occurred during the travel of a car over a reference distance (for example, see Japanese Patent Application Laid-open No. 2011-195253).

The related-art wear amount measurement device for an elevator as described above estimates the current wear amount of the sheave groove, but cannot predict a future wear amount of the sheave groove.

### SUMMARY OF THE INVENTION

This disclosure has been made in view of the above-mentioned problem, and has an object to obtain an elevator monitoring device, an elevator monitoring method, and a recording medium with which future wear amounts of a plurality of sheave grooves can be predicted more accurately.

According to at least one embodiment of this disclosure, there is provided an elevator monitoring device including a wear prediction unit configured to calculate a wear amount prediction value being a prediction value of a future wear amount that occurs in a set period in each of a plurality of sheave grooves through use of a wear prediction expression which uses, as inputs, a tension of a car-side portion and a tension of a counterweight-side portion in each of a plurality of ropes suspending a car and a counterweight, a slippage amount of each of the plurality of ropes, and material hardness of a sheave.

Further, according to at least one embodiment of this disclosure, there is provided an elevator monitoring method including a wear prediction step of calculating a wear amount prediction value being a prediction value of a future wear amount that occurs in a set period in each of a plurality of sheave grooves through use of a wear prediction expression which uses, as inputs, a tension of a car-side portion and a tension of a counterweight-side portion in each of a plurality of ropes suspending a car and a counterweight, a slippage amount of each of the plurality of ropes, and material hardness of a sheave.

According to this disclosure, it is possible to more accurately predict the future wear amounts of the plurality of sheave grooves.

### BRIEF DESCRIPTION OF THE DRAWINGS

FIG. 1 is a schematic configuration diagram for illustrating an elevator system in a first embodiment of this disclosure.

FIG. 2 is an explanatory diagram for illustrating tensions acting on each rope of FIG. 1.

FIG. 3 is a perspective view for illustrating a drive sheave of FIG. 2.

FIG. 4 is a sectional view for illustrating a first example of a sheave groove of FIG. 3.

FIG. 5 is a sectional view for illustrating a second example of the sheave groove of FIG. 3.

FIG. 6 is a block diagram for illustrating a control system of the elevator system of FIG. 1.

FIG. 7 is a flowchart for illustrating wear prediction processing by an elevator monitoring device of FIG. 6.

FIG. 8 is an explanatory diagram for illustrating an example of a calculation result of a wear amount prediction value in the sheave groove into which a first rope of FIG. 2 is inserted.

FIG. 9 is an explanatory diagram for illustrating an example of the calculation result of the wear amount prediction value in the sheave groove into which a second rope of FIG. 2 is inserted.

FIG. 10 is an explanatory diagram for illustrating an example of the calculation result of the wear amount prediction value in a second embodiment of this disclosure.

FIG. 11 is a block diagram for illustrating a control system of an elevator system in a third embodiment of this disclosure.

FIG. 12 is a block diagram for illustrating a control system of an elevator system in a fourth embodiment of this disclosure.

FIG. 13 is a block diagram for illustrating a control system of an elevator system in a fifth embodiment of this disclosure.

FIG. 14 is a block diagram for illustrating a control system of an elevator system in a sixth embodiment of this disclosure.

FIG. 15 is an explanatory diagram for illustrating an equivalent model of the rope passing over a pulley.

FIG. 16 is an explanatory diagram for illustrating a model in a one-dimensional coordinate system replacing the equivalent model of FIG. 15.

FIG. 17 is a flowchart for illustrating wear prediction processing by the elevator monitoring device of FIG. 14.

FIG. 18 is an explanatory diagram for illustrating a calculation method for the wear amount prediction value in a seventh embodiment of this disclosure.

FIG. 19 is a flowchart for illustrating wear prediction processing by the elevator monitoring device in the seventh embodiment.

FIG. 20 is a flowchart for illustrating wear prediction processing by the elevator monitoring device in an eighth embodiment of this disclosure.

FIG. 21 is an explanatory diagram for illustrating the equivalent model of FIG. 15 separately in a winding-up-side portion and a feeding-out-side portion.

FIG. 22 is an explanatory diagram for illustrating an elevator of FIG. 1 in a modeled manner.

FIG. 23 is a graph for showing a relationship between the tension of each of two ropes and a car position obtained when depths of two sheave grooves are equal to each other.

FIG. 24 is a graph for showing the relationship between the tension of each of the two ropes and the car position obtained when the depths of the two sheave grooves are different from each other by 0.2 mm.

FIG. 25 is a graph for showing a relationship between calculated values of the tension of each of the two ropes and the car position in comparison with each of a plurality of actual measurement values obtained when the depths of the two sheave grooves are different from each other by 0.7 mm.

FIG. 26 is a flowchart for illustrating wear prediction processing by the elevator monitoring device in a modification example of the eighth embodiment.

FIG. 27 is a schematic configuration diagram for illustrating an elevator system in a ninth embodiment of this disclosure.

FIG. 28 is an explanatory diagram for schematically illustrating a relationship among a car, the drive sheave, and a plurality of ropes.

FIG. 29 is an explanatory diagram for illustrating a state in which the car of FIG. 28 has approached the drive sheave.

FIG. 30 is a sectional view for illustrating an example of a wear state of each sheave groove in the drive sheave of FIG. 28.

FIG. 31 is a configuration diagram for illustrating a first example of a processing circuit for implementing each of functions of the elevator monitoring device according to the first embodiment to a tenth embodiment of this disclosure.

FIG. 32 is a configuration diagram for illustrating a second example of the processing circuit for implementing each of the functions of the elevator monitoring device according to the first embodiment to the tenth embodiment.

### DESCRIPTION OF THE EMBODIMENTS

Now, embodiments of this disclosure are described with reference to the drawings.

### First Embodiment

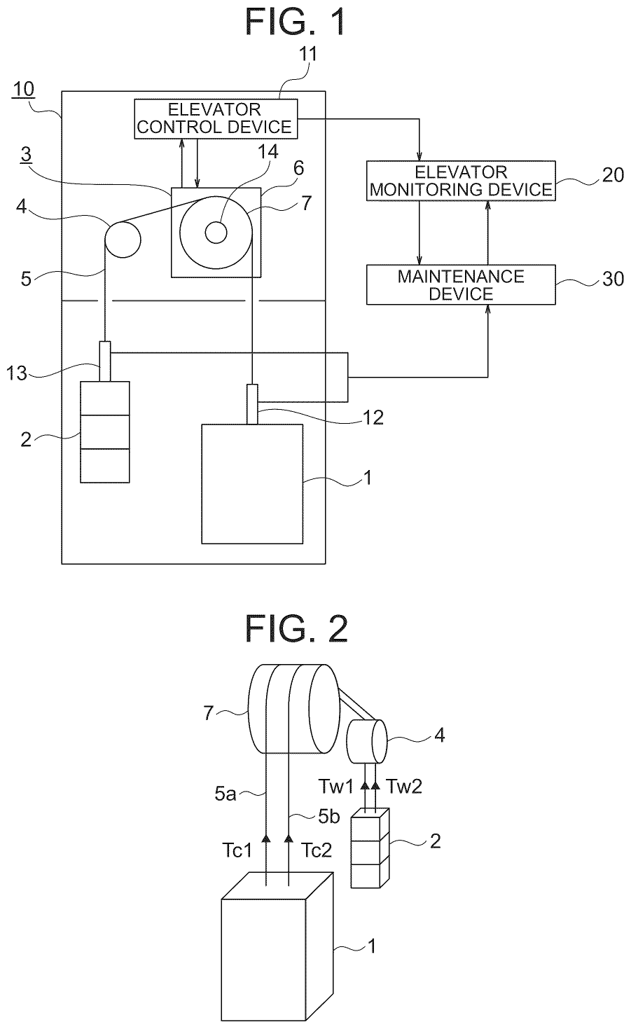

FIG. 1 is a schematic configuration diagram for illustrating an elevator system in a first embodiment of this disclosure. In FIG. 1, the elevator system includes an elevator device 10, an elevator monitoring device 20, and a maintenance device 30.

The elevator device 10 includes a car 1, a counterweight 2, a hoisting machine 3, a deflector sheave 4, a plurality of ropes 5, and an elevator control device 11. In FIG. 1, only one rope 5 is illustrated.

The hoisting machine 3 includes a hoisting machine main body 6 and a drive sheave 7. The hoisting machine main body 6 includes a hoisting machine motor (not shown) and a hoisting machine brake (not shown). The hoisting machine motor rotates the drive sheave 7. The hoisting machine brake holds the drive sheave 7 in a stationary state. Further, the hoisting machine brake brakes rotation of the drive sheave 7.

The plurality of ropes 5 are wound around the drive sheave 7 and the deflector sheave 4. The car 1 is connected to one end of each of the plurality of ropes 5. The counterweight 2 is connected to the other end of each of the plurality of ropes 5.

The car 1 and the counterweight 2 are suspended by the plurality of ropes 5. Further, the car 1 and the counterweight 2 are vertically moved by rotating the drive sheave 7. The elevator device 10 in the first embodiment is an elevator device of a 1:1 roping system.

The elevator control device 11 controls the hoisting machine 3, to thereby control an operation of the car 1.

A first tension measurement device 12 is provided in an end portion on the car 1 side in each of the plurality of ropes 5. A second tension measurement device 13 is provided in an end portion on the counterweight 2 side in each of the plurality of ropes 5. As each of the first tension measurement device 12 and the second tension measurement device 13, for example, a load cell can be used.

As the first tension measurement device 12 and the second tension measurement device 13, an accelerometer mounted to the rope 5 may be used. In this case, a vibration frequency of chord vibration of the rope 5 is measured by the accelerometer. After that, the vibration frequency is converted to a tension, to thereby obtain tension information. The accelerometer may be mounted to the rope 5 only at the time of maintenance and inspection work, or may always be mounted to the rope 5.

A rotation sensor 14 is provided to the hoisting machine 3. The rotation sensor 14 generates a signal in accordance with rotation of the drive sheave 7. As the rotation sensor 14, for example, an encoder is used.

The elevator monitoring device 20 monitors a state of the elevator device 10. Further, the elevator monitoring device 20 can communicate to and from the elevator control device 11. As a result, the elevator monitoring device 20 acquires various types of information on the state of the elevator device 10 from the elevator control device 11. Further, the signal from the rotation sensor 14 is input to the elevator monitoring device 20 via the elevator control device 11.

The maintenance device 30 is a terminal that a maintenance worker holds at the time of the maintenance and inspection work. The maintenance worker can acquire, from the maintenance device 30, the information on the elevator device 10 being a target of the maintenance and inspection. As the maintenance device 30, for example, a laptop personal computer, a tablet computer, or a smartphone can be used.

The maintenance device 30 can communicate to and from the elevator monitoring device 20. Further, a signal from the first tension measurement device 12 and a signal from the second tension measurement device 13 are input to the maintenance device 30.

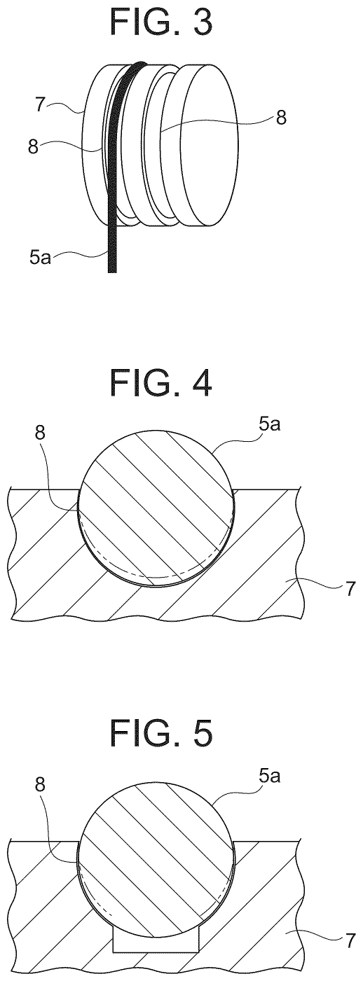

FIG. 2 is an explanatory diagram for illustrating tensions acting on each rope 5 of FIG. 1. In FIG. 2, two ropes 5 are illustrated for the convenience of simplicity, but the number of ropes 5 may be three or more.

A portion of each rope 5 on the car 1 side with respect to the drive sheave 7 is hereinafter referred to as “car-side portion.” Further, a portion of each rope 5 on the counterweight 2 side with respect to the drive sheave 7 is hereinafter referred to as “counterweight-side portion.” Further, one of the two ropes 5 is referred to as “first rope 5a,” and the other is referred to as “second rope 5b.”

A tension Tc1 of the car-side portion of the first rope 5a, a tension Tw1 of the counterweight-side portion of the first rope 5a, a tension Tc2 of the car-side portion of the second rope 5b, and a tension Tw2 of the counterweight-side portion of the second rope 5b are different from one another.

Normally, under a state in which no passenger exists in the car 1, a weight of the counterweight 2 is larger than a weight of the car 1. Further, under a state in which the car 1 is loaded with full capacity of passengers, the weight of the car 1 is larger than the weight of the counterweight 2.

Thus, under the state in which no passenger exists in the car 1, a relationship of (Tc1+Tc2)<(Tw1+Tw2) is satisfied. Further, under the state in which the car 1 is loaded with full capacity of passengers, a relationship of (Tc1+Tc2)>(Tw1+Tw2) is satisfied.

When the tensions act on each rope 5, stretch corresponding to magnitudes of the tensions occurs in each rope 5. For example, under such a tension condition as Tc1<Tc2, a relationship of (stretch amount of car-side portion of first rope 5a)<(stretch amount of car-side portion of second rope 5b) is satisfied.

When the drive sheave 7 rotates in a direction of causing the car 1 to ascend, the car-side portion of the first rope 5a is wound up, and the counterweight-side portion of the first rope 5a is fed out. At this time, the stretch amount of the car-side portion of the first rope 5a and the stretch amount of the counterweight-side portion of the first rope 5a are different from each other.

Thus, the first rope 5a is guided by the drive sheave 7 while minutely slipping on the drive sheave 7 by a difference in stretch amount between the car-side portion and the counterweight-side portion. An amount of this minute slippage on the drive sheave 7 is referred to as “creep amount.” Further, a value of the creep amount increases as the difference between the tension of the car-side portion and the tension of the counterweight-side portion increases.

FIG. 3 is a perspective view for illustrating the drive sheave 7 of FIG. 2. Although illustration is omitted in FIG. 2, a plurality of sheave grooves 8 are formed in an outer circumferential surface of the drive sheave 7. Each rope 5 is inserted into a corresponding sheave groove 8. In FIG. 3, illustration of the second rope 5b is omitted.

FIG. 4 is a sectional view for illustrating a first example of the sheave groove 8 of FIG. 3. In the first example, a cross section of a bottom surface of the sheave groove 8 is in an arc shape.

FIG. 5 is a sectional view for illustrating a second example of the sheave groove 8 of FIG. 3. In the second example, an undercut groove is formed in the bottom surface of the sheave groove 8.

On the bottom surface of each sheave groove 8, a surface pressure corresponding to the magnitude of the tensions acting on a corresponding rope 5 acts. Thus, through an operation of the car 1, the bottom surface of each sheave groove 8 wears over time, and a depth of each sheave groove 8 increases. In each of FIG. 4 and FIG. 5, an initial position of the bottom surface of the sheave groove 8 is indicated by the two-dot chain line.

The wear of the bottom surface of the sheave groove 8 progresses more rapidly as the surface pressure acting on the bottom surface is larger. Further, the wear of the bottom surface of the sheave groove 8 progresses more rapidly as the slippage amount of the rope 5 in the sheave groove 8 is larger. That is, as the difference between the tension of the car-side portion and the tension of the counterweight-side portion of the rope 5 is larger, the value of the creep amount is larger, and the wear progresses more rapidly.

A sectional shape of the sheave groove 8 is not limited to those of the first example and the second example, and may be in a V shape.

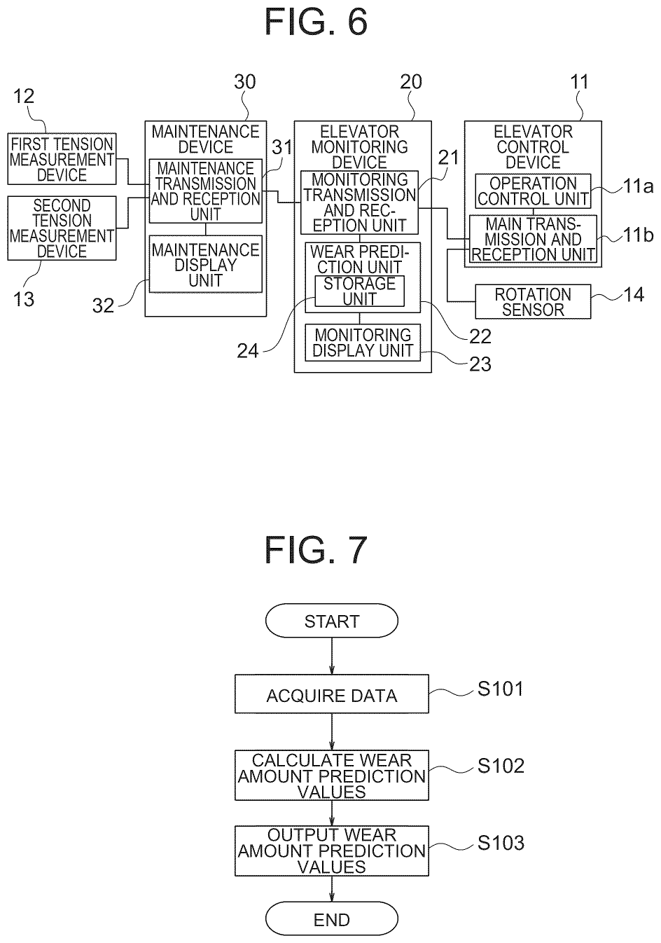

FIG. 6 is a block diagram for illustrating a control system of the elevator system of FIG. 1. The elevator control device 11 includes, as functional blocks, an operation control unit 11a and a main transmission and reception unit 11b. The operation control unit 11a controls the operation of the car 1. The main transmission and reception unit 11b transmits and receives signals to and from devices external to the elevator control device 11.

Further, in the elevator control device 11, a history of travel patterns of the car 1 up to the current time is stored.

The maintenance device 30 includes, as functional blocks, a maintenance transmission and reception unit 31 and a maintenance display unit 32. The maintenance transmission and reception unit 31 transmits and receives signals to and from devices external to the maintenance device 30.

To the maintenance device 30, a maintenance display (not shown) is provided. The maintenance display unit 32 displays information required for the maintenance work for the elevator device 10 on the maintenance display.

The elevator monitoring device 20 includes, as functional blocks, a monitoring transmission and reception unit 21, a wear prediction unit 22, and a monitoring display unit 23. The monitoring transmission and reception unit 21 transmits and receives signals to and from devices external to the elevator monitoring device 20.

To the elevator monitoring device 20, a monitoring display (not shown) is provided. The monitoring display unit 23 displays information required for the monitoring for the elevator device 10 on the monitoring display.

The wear prediction unit 22 calculates a plurality of wear amount prediction values through use of a wear prediction expression. Each of the plurality of wear amount prediction values is a prediction value of a future wear amount that occurs in each of the plurality of sheave grooves 8 in a set period. The wear prediction expression uses, as inputs, the tension of the car-side portion and the tension of the counterweight-side portion of each of the plurality of ropes 5, the slippage amount of each of the plurality of ropes 5, and material hardness of the drive sheave 7.

Further, the wear prediction unit 22 outputs the plurality of wear amount prediction values to the monitoring display unit 23. The monitoring display unit 23 displays the plurality of wear amount prediction values on the monitoring display. Further, the wear prediction unit 22 outputs, via the monitoring transmission and reception unit 21, the plurality of wear amount prediction values to the maintenance device 30. The maintenance display unit 32 displays the plurality of wear amount prediction values on the maintenance display.

As an example of a method of displaying the plurality of wear amount prediction values, a two-dimensional sectional shape of the sheave groove 8 illustrated in FIG. 4 or FIG. 5 may be displayed on the maintenance display.

The wear prediction unit 22 includes a storage unit 24. The storage unit 24 stores the wear prediction expression and the plurality of wear amount prediction values.

Description is now given of a specific calculation method for the plurality of wear amount prediction values. The wear prediction expression is a relational expression as given below.

Wear amount=(f(slippage amount,tensions,sheave hardness)/travel of elevator)×reference traveling distance

The wear prediction unit 22 acquires, from the first tension measurement device 12 via the maintenance device 30, an average value of the tension of the car-side portion in each of the plurality of ropes 5. The average value of the tension of the car-side portion of each rope 5 is a value obtained by averaging a tension variation of the car-side portion for each rope 5 when the car 1 travels from the lowest floor to the highest floor.

Further, the wear prediction unit 22 acquires, from the second tension measurement device 13 via the maintenance device 30, an average value of the tension of the counterweight-side portion in each of the plurality of ropes 5. The average value of the tension of the counterweight-side portion of each rope 5 is a value obtained by averaging a tension variation of the counterweight-side portion for each rope 5 when the car 1 travels from the lowest floor to the highest floor.

Thus, each average value includes the tension variation caused by the movement of the car 1.

At the time of the maintenance and inspection, the maintenance worker measures the average value of the tension of the car-side portion and the average value of the tension of the counterweight-side portion in each of the plurality of ropes 5, and inputs the average values to the maintenance device 30. The average values of the tensions may automatically be transmitted to the maintenance device 30 without an intermediation of the maintenance worker.

The calculation of the average values may be executed by the first tension measurement device 12 and the second tension measurement device 13, or may be executed by the maintenance device 30. Further, the wear prediction unit 22 may calculate the average values of the tensions based on the tensions acquired from the first tension measurement device 12 and the second tension measurement device 13.

Further, the wear prediction unit 22 acquires, from the elevator control device 11, data on a rotation amount of the drive sheave 7 and data on the travel distance of the car 1. The data on the rotation amount is a measurement value of the rotation amount of the drive sheave 7 up to the current time.

The wear prediction unit 22 calculates the slippage amount of the rope 5 from a difference between the most recent rotation amount of the drive sheave 7 and the most recent travel distance of the car 1.

As the most recent rotation amount of the drive sheave 7 and the most recent travel distance of the car 1, values obtained by causing the car 1 to make a round travel at the time of the maintenance and inspection may be used.

The sheave hardness is material hardness of the drive sheave 7, and is input to and stored in the elevator monitoring device 20 in advance.

The wear prediction unit 22 inputs the average value of the tension of the car-side portion in each rope 5, the average value of the tension of the counterweight-side portion in each rope 5, the slippage amount of each rope 5, and the sheave hardness to the wear prediction expression, to thereby calculate the plurality of wear amount prediction values.

f(slippage amount, tensions, sheave hardness) in the wear prediction expression is an estimation value of a wear amount that occurs when the car 1 travels in the current state once over a distance corresponding to a distance from the lowest floor to the highest floor. Further, f (slippage amount, tensions, sheave hardness) is a relational expression described as a function of the slippage amount of the rope 5, the tensions, and the sheave hardness.

For example, as f (slippage amount, tensions, sheave hardness), the following relational expression can be used.

f(slippage amount, tensions, sheave

$$hardness ) = α \times ( P ( T ) L ) / H$$

In the relational expression, symbol P(T) is the surface pressure acting on the sheave groove 8, and is a function of a tension T. Symbol L is a slippage amount that occurs when the car 1 travels once over the distance corresponding to the distance from the lowest floor to the highest floor. Symbol H is the sheave hardness. Symbol α is a proportional constant.

Further, the reference travel distance is an average travel distance over which the car 1 travels in a set period. The wear prediction unit 22 estimates a wear amount that occurs in the set period through use of the wear prediction expression. The set period is an interval of periodical maintenance and inspection, for example, three months. However, the set period is not limited to the interval of the maintenance and inspection, and can be set to any appropriate period.

The tensions assigned to the right side of the wear prediction expression are used to calculate the surface pressure applied to the sheave groove 8. Thus, as the tension of the car-side portion, a value obtained by adding a rope weight corresponding to a length of the car-side portion to the data measured by the first tension measurement device 12 is used. Further, as the tension of the counterweight-side portion, a value obtained by adding a rope weight corresponding to a length of the counterweight-side portion to the data measured by the second tension measurement device 13 is used.

The plurality of wear amount prediction values calculated by the wear prediction unit 22 are transmitted to the maintenance device 30, and are displayed on the maintenance display. The maintenance worker checks the plurality of wear amount prediction values displayed on the maintenance display. When a wear r amount exceeding a reference is predicted, the maintenance worker plans to perform regrooving work of equalizing the depths of the sheave grooves 8 at a time before a time at which the wear amount exceeds the reference.

As a result, it is possible to take measures before a defect due to the wear of the sheave groove 8 occurs.

A diameter of each rope 5 also decreases over time as a result of the operation of the elevator device. When the diameter of each rope 5 decreases, an effective diameter of the drive sheave 7 is reduced similarly to the wear of the sheave groove 8. In order to distinguish the wear amount of the sheave groove 8 and the reduction in diameter of the rope 5 from each other, it is only required to subtract a decrease amount of the diameter of the rope 5 measured at the time of the maintenance and inspection from the estimated wear amount of the sheave groove 8.

FIG. 7 is a flowchart for illustrating the wear prediction processing by the elevator monitoring device 20 of FIG. 6. When the wear prediction processing is started, the elevator monitoring device 20 acquires the data to be input to the wear prediction expression in Step S101.

Subsequently, the elevator monitoring device 20 calculates the plurality of wear amount prediction values through use of the wear prediction expression in Step S102. After that, the elevator monitoring device 20 outputs the plurality of wear amount prediction values to the maintenance device 30 in Step S103. Further, the elevator monitoring device 20 displays the plurality of wear amount prediction values on the monitoring display.

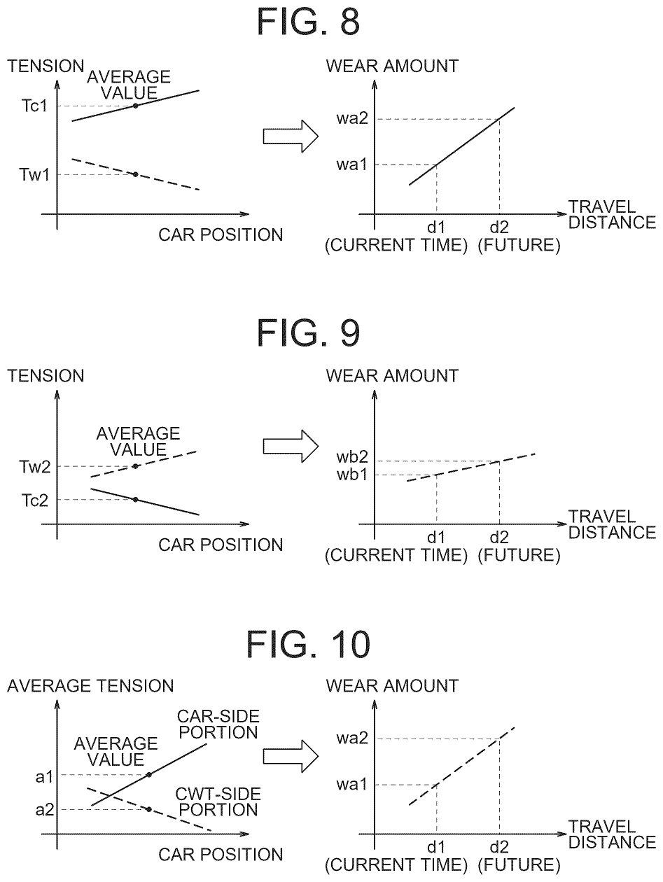

FIG. 8 is an explanatory diagram for illustrating an example of a calculation result of the wear amount prediction value in the sheave groove 8 into which the first rope 5a of FIG. 2 is inserted. A left graph of FIG. 8 shows a measurement result of the tension of the car-side portion and a measurement result of the tension of the counterweight-side portion. A right graph of FIG. 8 is a graph for showing a current wear amount in the sheave groove 8 into which the first rope 5a is inserted and a future wear amount after the car 1 travels for the set period.

FIG. 9 is an explanatory diagram for illustrating an example of the calculation result of the wear amount prediction value in the sheave groove 8 into which the second rope 5b of FIG. 2 is inserted. A left graph of FIG. 9 shows a measurement result of the tension of the car-side portion and a measurement result of the tension of the counterweight-side portion. A right graph of FIG. 9 is a graph for showing a current wear amount in the sheave groove 8 into which the second rope 5b is inserted and a future wear amount after the car 1 travels for the set period.

In the examples of FIG. 8 and FIG. 9, (average value of Tc1 and Tw1)>(average value of Tc2 and Tw2).

Further, in the examples of FIG. 8 and FIG. 9, |Tc1−Tw1|>|Tc2−Tw2|. That is, the first rope 5a is larger than the second rope 5b in values of the surface pressure and the creep amount. As the value of the creep amount is larger, the wear of the sheave groove 8 progresses more rapidly. Thus, in the right graph of FIG. 8, a gradient of the wear amount is larger than a gradient of the wear amount in the right graph of FIG. 9.

As illustrated in FIG. 8 and FIG. 9, it is possible to predict the progress of the wear amount for each sheave groove 8.

An elevator monitoring method according to the first embodiment includes a wear prediction step. The wear prediction step is a step of calculating, through use of the wear prediction expression, the wear amount prediction value being the prediction value of the future wear amount that occurs in each of the plurality of sheave grooves 8 in the set period.

In the above-mentioned elevator monitoring device 20 and elevator monitoring method, the wear amount prediction values are calculated through use of the wear prediction expression which use, as inputs, the tension of the car-side portion, the tension of the counterweight-side portion, the slippage amount of each of the plurality of ropes 5, and the material hardness of the drive sheave 7. Thus, it is possible to more accurately predict the future wear amount of each of the plurality of sheave grooves 8.

Further, the wear prediction unit 22 calculates the surface pressure acting on each of the plurality of sheave grooves 8 through use of the tension of each of the plurality of ropes 5 in the wear prediction expression. Further, the wear prediction unit 22 calculates the creep amount as the slippage amount from the difference between the rotation amount of the drive sheave 7 and the travel distance of the car 1. Thus, it is possible to more accurately predict the future wear amount of each of the plurality of sheave grooves 8.

Further, the wear prediction unit 22 acquires the average value of the tension of the car-side portion and the average value of the tension of the counterweight-side portion in each of the plurality of ropes 5. After that, the wear prediction unit 22 calculates the surface pressure acting on each of the plurality of sheave grooves 8, and calculates the wear amount prediction value for each of the plurality of sheave grooves 8.

Thus, it is possible to more accurately predict the future wear amount in each of the plurality of sheave grooves 8. As a result, the maintenance worker refers to the plurality of wear amount prediction values, and releases the tension of the rope 5 applied to the sheave groove 8 in which the wear is predicted to progress rapidly, thereby being able to suppress imbalance in the progress of the wear.

Further, each average value acquired by the wear prediction unit 22 includes the tension variation due to the movement of the car 1. Thus, it is possible to more accurately predict the future wear amount in each of the plurality of sheave grooves 8.

An elevator monitoring program according to the first embodiment is a program for causing a computer to execute the above-mentioned elevator monitoring method.

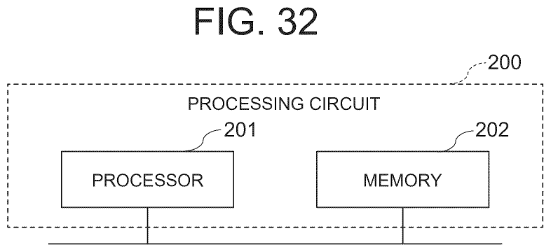

Further, the program is generally stored in a storage medium as a recording medium in a readable form, for example, a memory 202 of FIG. 32. After that, processing described in the program read from the storage medium is executed by the computer. A recording medium according to the first embodiment is a computer-readable recording medium having recorded thereon an elevator monitoring program for causing the computer to execute the above-mentioned elevator monitoring method.

### Second Embodiment

Next, an elevator system in a second embodiment of this disclosure is described. A configuration of the elevator system in the second embodiment is the same as that of FIG. 1. Further, a control system of the elevator system in the second embodiment is the same as that of FIG. 6.

However, the wear prediction unit 22 in the second embodiment acquires, as the tensions of the plurality of ropes 5 to be input to the wear prediction expression, an average value of the average tensions of all of the car-side portions in the plurality of ropes 5 and an average value of the average tensions of all of the counterweight-side portions in the plurality of ropes 5.

FIG. 10 is an explanatory diagram for illustrating an example of the calculation result of the wear amount prediction value in the second embodiment. A left graph of FIG. 10 shows a measurement result of the average tensions of all of the car-side portions and a measurement result of the average tensions of all of the counterweight-side portions.

The average tension is a value obtained by averaging all tension variations of the rope 5. Symbol a1 of FIG. 10 is an average value of the average tensions each obtained by averaging all tension variations of the car-side portion. Symbol a2 of FIG. 10 is an average value of the average tensions each obtained by averaging all tension variations of the counterweight-side portion.

A right graph of FIG. 10 is a graph for showing a current averaged wear amount in all of the sheave grooves 8 and a future averaged wear amount after the car 1 travels for the set period. The averaged wear amount is the average value of the wear amounts of the plurality of sheave grooves 8.

Also in this case, each average value includes the tension variation caused by the movement of the car 1.

Other configurations and a monitoring method in the second embodiment are the same as those in the first embodiment.

Even with the configuration described above, it is possible to more accurately predict the future wear amounts of the plurality of sheave grooves 8. Further, the processing can be simplified through use of the average value of the average tensions.

An elevator monitoring program according to the second embodiment is a program for causing a computer to execute processing of the monitoring method by the elevator monitoring device 20 according to the second embodiment. Further, a recording medium according to the second embodiment is a computer-readable recording medium having recorded thereon the elevator monitoring program according to the second embodiment.

### Third Embodiment

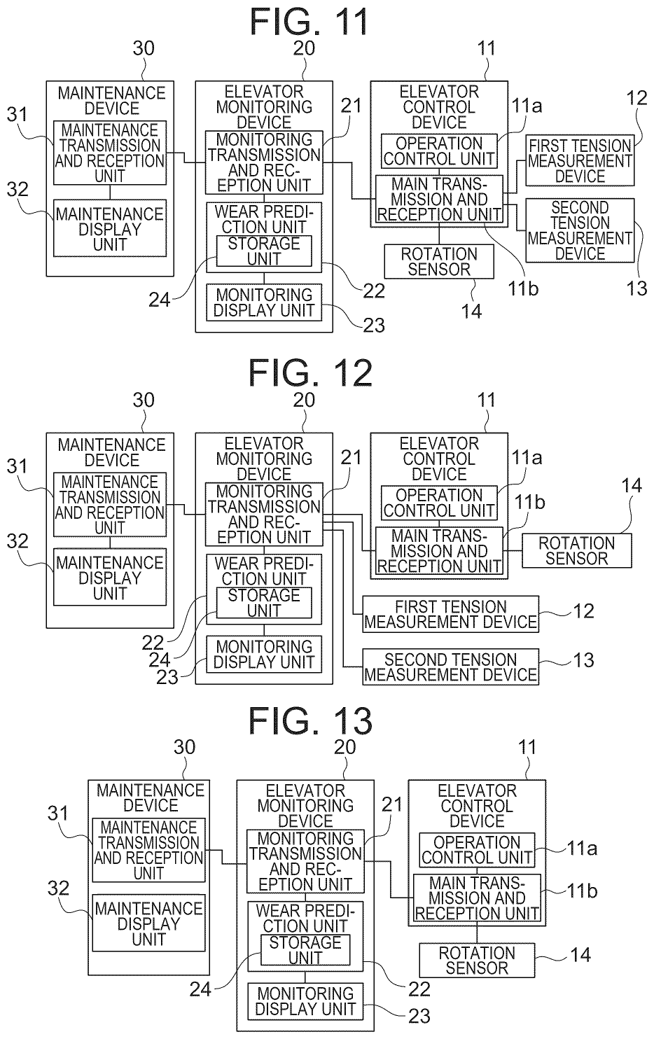

Next, FIG. 11 is a block diagram for illustrating a control system of an elevator system in a third embodiment of this disclosure. In the third embodiment, the measurement data on the tension is transmitted from the first tension measurement device 12 and the second tension measurement device 13 to the elevator control device 11. The elevator control device 11 transmits the measurement data on the tension to the elevator monitoring device 20 in response to a request from the elevator monitoring device 20 or automatically.

The elevator monitoring device 20 is installed in, for example, a maintenance center remote from the elevator device 10.

Other configurations and a monitoring method in the third embodiment are the same as those in the first embodiment or the second embodiment.

Even with the configuration described above, it is possible to more accurately predict the future wear amounts of the plurality of sheave grooves 8.

An elevator monitoring program according to the third embodiment is a program for causing a computer to execute processing of the monitoring method by the elevator monitoring device 20 according to the third embodiment. Further, a recording medium according to the third embodiment is a computer-readable recording medium having recorded thereon the elevator monitoring program according to the third embodiment.

### Fourth Embodiment

Next, FIG. 12 is a block diagram for illustrating a control system of an elevator system in a fourth embodiment of this disclosure. In the fourth embodiment, the measurement data on the tension is directly transmitted from the first tension measurement device 12 and the second tension measurement device 13 to the elevator monitoring device 20 in response to a request from the elevator monitoring device 20 or automatically.

Other configurations and a monitoring method in the fourth embodiment are the same as those in the first embodiment or the second embodiment.

Even with the configuration described above, it is possible to more accurately predict the future wear amounts of the plurality of sheave grooves 8.

An elevator monitoring program according to the fourth embodiment is a program for causing a computer to execute processing of the monitoring method by the elevator monitoring device 20 according to the fourth embodiment. Further, a recording medium according to the fourth embodiment is a computer-readable recording medium having recorded thereon the elevator monitoring program according to the fourth embodiment.

In the first embodiment to the fourth embodiment, one of the first tension measurement device 12 or the second tension measurement device 13 may be omitted. For example, when the second tension measurement device 13 is omitted, the tension of the counterweight-side portion can be calculated from a design value of the weight of the counterweight 2.

### Fifth Embodiment

Next, FIG. 13 is a block diagram for illustrating a control system of an elevator system in a fifth embodiment of this disclosure. In the fifth embodiment, none of the first tension measurement device 12 and the second tension measurement device 13 are used. Instead, the storage unit 24 stores, in advance, the average value of the average tensions of all of the car-side portions and the average value of the average tensions of all of the counterweight-side portions in the second embodiment.

The average value of the average tensions of all of the car-side portions is a value calculated through an expression of the car mass/the number of ropes. The average value of the average tensions of all of the counterweight-side portions is a value calculated through an expression of the counterweight mass/the number of ropes.

The wear prediction unit 22 inputs each average value stored in advance to the wear prediction expression, to thereby calculate the plurality of wear amount prediction values.

Other configurations and a monitoring method in the fifth embodiment are the same as those in the second embodiment.

Even with the configuration described above, it is possible to more accurately predict the future wear amounts of the plurality of sheave grooves 8. Further, each average value is stored in advance, and hence the configuration can be simplified, and time and effort for the tension measurement can be reduced.

An elevator monitoring program according to the fifth embodiment is a program for causing a computer to execute processing of the monitoring method by the elevator monitoring device 20 according to the fifth embodiment. Further, a recording medium according to the fifth embodiment is a computer-readable recording medium having recorded thereon the elevator monitoring program according to the fifth embodiment.

In the first embodiment to the fifth embodiment, the signal from the rotation sensor 14 may be directly transmitted to the elevator monitoring device 20 without an intermediation of the elevator control device 11.

### Sixth Embodiment

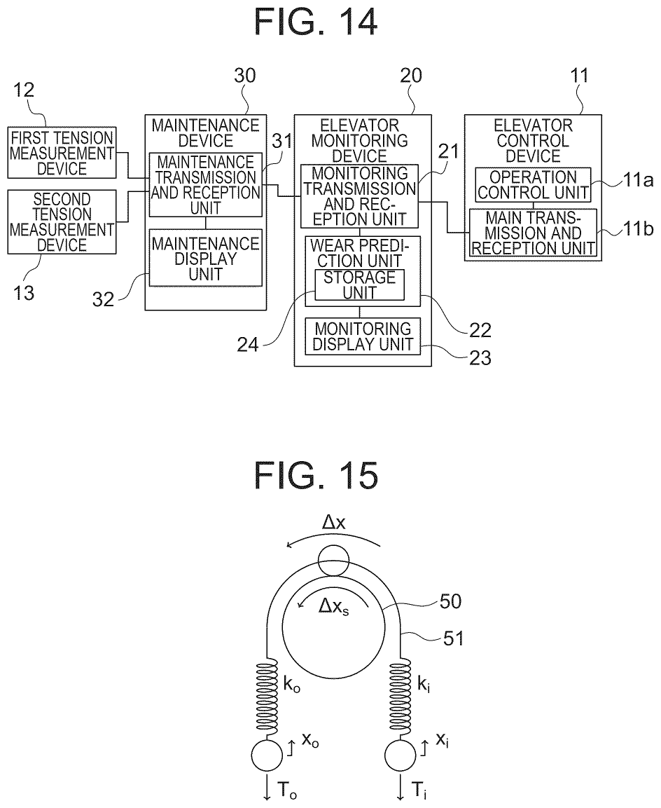

Next, FIG. 14 is a block diagram for illustrating a control system of an elevator system in a sixth embodiment of this disclosure. In the sixth embodiment, the rotation sensor 14 in the first embodiment is omitted.

In the wear prediction unit 22, two types of slippage amount calculation expressions, that is, a first slippage amount calculation expression and a second slippage amount calculation expression are stored. The storage unit 24 stores the first slippage amount calculation expression and the second slippage amount calculation expression. The two types of slippage amount calculation expressions are each an expression for obtaining a slippage amount estimation value. The slippage amount estimation value is an estimation value of the slippage amount of each of the plurality of ropes 5.

The wear prediction unit 22 uses the slippage amount estimation value as the slippage amount of each of the plurality of ropes 5 to be input to the wear prediction expression.

Further, the wear prediction unit 22 determines which one of the two types of slippage amount calculation expressions is to be selected in accordance with whether or not a ratio between the tension of the car-side portion and the tension of the counterweight-side portion exceeds a limit traction ratio T.

When the ratio between the tension of the car-side portion and the tension of the counterweight-side portion does not exceed the limit traction ratio T, the following first slippage amount calculation expression is selected.

$$Slippage amount estimation value = {\int }_{0}^{TR} Δ cr dx = {\int }_{0}^{TR} ( Δ uo - Δ ui ) dx$$

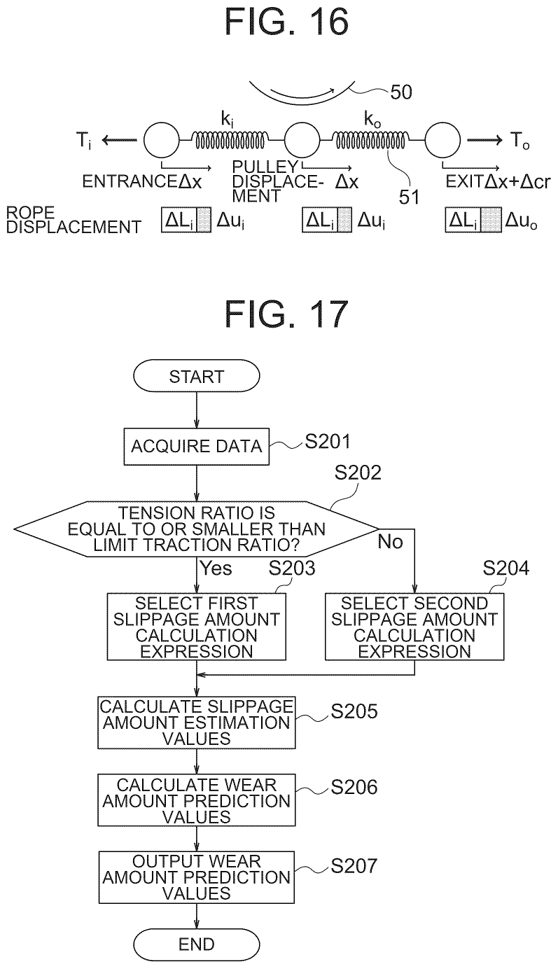

The simplest model in which one rope is wound around one pulley is now considered. FIG. 15 is an explanatory diagram for illustrating an equivalent model of the rope passing over the pulley. FIG. 16 is an explanatory diagram for illustrating a model in a one-dimensional coordinate system replacing the equivalent model of FIG. 15.

Around a pulley model 50, a rope model 51 is wound. The pulley model 50 rotates in a counterclockwise direction of FIG. 15 and FIG. 16. A movement direction of the rope model 51 is determined in correspondence to the rotation direction of the pulley model 50. In particular, in the model of the rope model 51 in the one-dimensional coordinate system illustrated in FIG. 16, a winding-up-side portion and a feeding-out-side portion of the rope model 51 move in the same direction in correspondence to the rotation direction of the pulley model 50.

In the equivalent model, it is assumed that the rope model 51 is formed of three portions of the winding-up-side portion, the feeding-out-side portion, and a portion moving integrally with the pulley model 50 as illustrated in FIG. 15 and FIG. 16. The portion moving integrally with the pulley model 50 is more accurately a portion which is on the pulley model 50, and is movable integrally with the pulley model 50.

In the following description, a suffix “i” is added to a variable relating to the winding-up-side portion of the rope model 51 in such a sense that the variable is on the input side. The winding-up-side portion is a portion of the rope model 51 on an upstream side with respect to the pulley model 50 in terms of the moving direction of the rope model 51.

Further, a suffix “o” is added to a variable relating to the feeding-out-side portion of the rope model 51 in such a sense that the variable is on the output side. The feeding-out-side portion of the rope model 51 is a portion of the rope model 51 on a downstream side with respect to the pulley model 50 in terms of the moving direction of the rope model 51.

When the rope model 51 is wound up by Δx being a minute winding-up amount through minute rotation of the pulley model 50, the winding-up amount Δx is represented as a sum of a rope free length ΔLi and a rope stretch amount Δui. The rope free length ΔLi is a length in a state in which the tensions are not acting.

That is, the winding-up amount Δx corresponds to a rope displacement amount in a state in which the tensions are acting, and is a value obtained by adding the rope stretch amount caused by the tensions to the rope free length ΔLi being a rope displacement amount in a state in which the tensions are not acting. As illustrated in FIG. 16, rope displacement amounts of the winding-up-side portion, the feeding-out-side portion, and the portion moving integrally with the pulley in the state in which the tensions are not acting are the same rope free length ΔLi.

$$Δ x = Δ Li + Δ ui \qquad ( 1.1 )$$

The rope stretch amount Δui of the winding-up-side portion is obtained from a tension Ti of the winding-up-side portion. Meanwhile, a tension of the feeding-out-side portion is To, and hence a rope stretch amount Δuo of the freed-out-side portion is different from the rope stretch amount Δui of the winding-up-side portion.

Thus, a creep amount Δcr, which is a minute slippage amount of the rope model 51 on the pulley model 50, is a rope stretch amount difference Δuo−Δui with respect to the rope free length ΔLi.

$$Δ cr = Δ uo - Δ ui$$

A creep amount at the time of the travel of the car 1 from the lowest floor to the highest floor is obtained by integrating the creep amount Δcr from 0 by a length TR of travel of elevator.

Meanwhile, when the ratio between the tension of the car-side portion and the tension of the counterweight-side portion exceeds the limit traction ratio T, the following second slippage amount calculation expression is selected.

$$Slippage amount estimation value = ( Tw 1 ( x ) - Γ Tc 1 ( x ) ) / ( kw ( x ) + Γ kc ( x ) )$$

In the first rope 5a of FIG. 2, when the ratio between the tension of the car-side portion and the tension of the counterweight-side portion exceeds the limit traction ratio Γ, the slippage amount of the first rope 5a on the drive sheave 7 is calculated through the second slippage amount calculation expression. Symbol kc is stiffness of the car-side portion of the first rope 5a. Symbol kw is stiffness of the counterweight-side portion of the first rope 5a.

When the slippage amount estimation value is calculated for the second rope 5b of FIG. 2, it is only required to assign Tc2 and Tw2 to tension terms of the second slippage amount calculation expression.

A slippage amount that occurs when the limit traction ratio Γ is exceeded is larger than a creep amount that occurs when the limit traction ratio Γ is not exceeded.

FIG. 17 is a flowchart for illustrating wear prediction processing by the elevator monitoring device 20 of FIG. 14. When the wear prediction processing is started, the elevator monitoring device 20 acquires required data in Step S201.

Subsequently, the elevator monitoring device 20 determines whether or not the tension ratio is equal to or smaller than the limit traction ratio Γ in Step S202. When the tension ratio is equal to or smaller than the limit traction ratio Γ, that is, when the tension ratio does not exceed the limit traction ratio, the elevator monitoring device 20 selects the first slippage amount calculation expression in Step S203.

When the tension ratio is not equal to or smaller than the limit traction ratio Γ, that is, when the tension ratio exceeds the limit traction ratio Γ, the elevator monitoring device 20 selects the second slippage amount calculation expression in Step S204.

After that, the elevator monitoring device 20 calculates the slippage amount estimation values through use of the first slippage amount calculation expression or the second slippage amount calculation expression in Step S205. After that, the elevator monitoring device 20 calculates the plurality of wear amount prediction values through use of the wear prediction expression in Step S206.

After that, the elevator monitoring device 20 outputs the plurality of wear amount prediction values to the maintenance device 30 in Step S207. Further, the elevator monitoring device 20 displays the plurality of wear amount prediction values on the monitoring display.

Other configurations and a monitoring method in the sixth embodiment are the same as those in the first embodiment or the second embodiment.

Even with the configuration and the monitoring method described above, it is possible to more accurately predict the future wear amounts of the plurality of sheave grooves 8.

Further, the wear prediction unit 22 uses, as the slippage amount, the slippage amount estimation value calculated through use of the slippage amount calculation expression. Thus, it is possible to more accurately predict the future wear amounts of the plurality of sheave grooves 8.

Further, the wear prediction unit 22 determines which of the first slippage amount calculation expression and the second slippage amount calculation expression is to be selected in accordance with whether or not the ratio between the tension of the car-side portion and the tension of the counterweight-side portion exceeds the limit traction ratio. Thus, even for the large slippages of the plurality of ropes 5 due to the tension ratio exceeding the limit traction ratio T, it is possible to more accurately predict the future wear amounts of the plurality of sheave grooves 8.

An elevator monitoring program according to the sixth embodiment is a program for causing a computer to execute processing of the monitoring method by the elevator monitoring device 20 according to the sixth embodiment. Further, a recording medium according to the sixth embodiment is a computer-readable recording medium having recorded thereon the elevator monitoring program according to the sixth embodiment.

### Seventh Embodiment

Next, an elevator system in a seventh embodiment of this disclosure is described. A configuration of the elevator system in the seventh embodiment is the same as that of FIG. 1. Further, a control system of the elevator system in the seventh embodiment is the same as that of FIG. 6.

In the seventh embodiment, the momentary tension of the car-side portion of each of the plurality of ropes 5 is continuously measured by the first tension measurement device 12. Further, the momentary tension of the counterweight-side portion of each of the plurality of ropes 5 is continuously measured by the second tension measurement device 13.

In the elevator control device 11, information on an in-car load acquired from a load weighting device (not shown) is accumulated. Further, in the elevator control device 11, a history of each of a car travel distance, a car stop position, and the in-car load from start of use of the elevator device 10 to the current time is accumulated.

The wear prediction unit 22 inputs the momentary tension data to the wear prediction expression, to thereby calculate a wear amount momentary value of each of the plurality of sheave grooves 8. Further, the wear prediction unit 22 accumulates each wear amount momentary value, to thereby calculate the wear amount prediction value of each sheave groove 8.

Further, the wear prediction unit 22 updates parameters of the wear prediction expression through use of a past state quantity. The past state quantity includes past tension data, past rotation amounts of the drive sheave 7, past travel amounts of the car 1, past wear amounts, and past in-car loads.

As described above, through use of the past data, the constants included in the wear prediction expression are updated to match a wear gradient being an actual measurement value, and thus the wear prediction expression is adjusted for each elevator device 10.

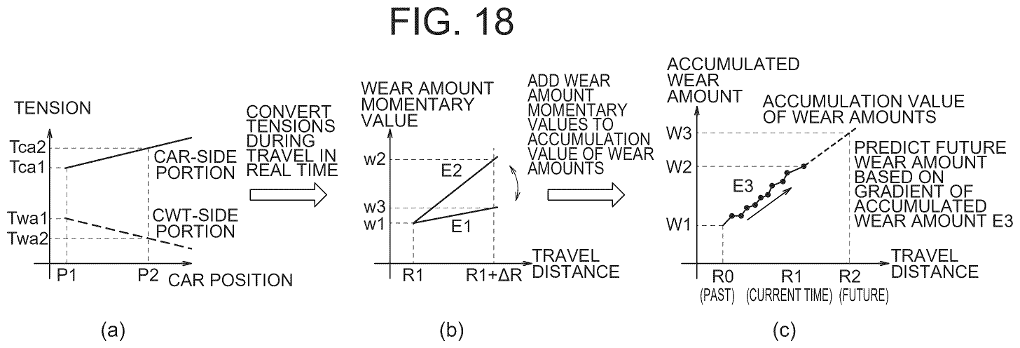

FIG. 18 is an explanatory diagram for illustrating a calculation method for the wear amount prediction value in the seventh embodiment. In FIG. 18, a calculation method for the wear amount prediction value of the sheave groove 8 corresponding to the first rope 5a of FIG. 2 is illustrated.

In (a) of FIG. 18, actual measurement values of the first rope 5a are shown. When the car 1 is positioned at a position P1, it is assumed that the tension of the car-side portion is Tca1 and the tension of the counterweight-side portion is Twa1. Further, when the car 1 is positioned at a position P2, it is assumed that the tension of the car-side portion is Tca2 and the tension of the counterweight-side portion is Twa2.

As described above, it is assumed that the tension varies in accordance with the car position, and the surface pressure acting on the sheave groove 8 varies in accordance with the car position.

For example, when the car 1 is positioned at the position P1, the surface pressure is low, and the wear amount momentary value is indicated by a straight line E1 in (b) of FIG. 18. Further, when the car 1 is positioned at the position P2, the surface pressure is higher than that at the time when the car 1 is positioned at the position P1, and the wear amount momentary value is indicated by a straight line E2 in (b) of FIG. 18.

Moreover, as illustrated in (c) of FIG. 18, E3, which is a gradient of the accumulation value of the wear amounts, is output based on the accumulation of such wear amount momentary values.

In the seventh embodiment, the wear amount assumed when a tendency of the gradient E3 from the past to the current time continues also in the future is calculated as the wear amount prediction value.

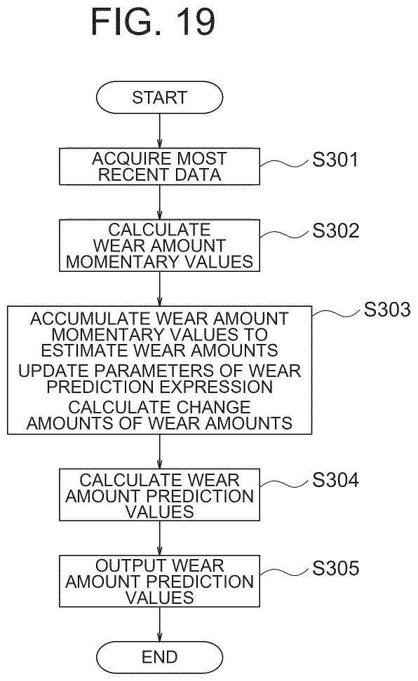

FIG. 19 is a flowchart for illustrating wear prediction processing by the elevator monitoring device 20 in the seventh embodiment. When the wear prediction processing is started, the elevator monitoring device 20 acquires the most recent data in Step S301. In the most recent data, the most recent tension data, the most recent rotation amount of the drive sheave 7, and the most recent travel distance of the car 1 are included.

Subsequently, the elevator monitoring device 20 calculates the wear amount momentary values through use of the wear prediction expression in Step S302.

After that, the elevator monitoring device 20 accumulates the wear amount momentary values to estimate the wear amounts in Step S303. Further, the elevator monitoring device 20 updates the parameters of the wear prediction expression through use of the past state quantity. Further, the elevator monitoring device 20 calculates the change amounts of the wear amounts from data including the past history.

After that, the elevator monitoring device 20 calculates the plurality of wear amount prediction values in the future in the set period in Step S304. Then, the elevator monitoring device 20 outputs the plurality of wear amount prediction values to the maintenance device 30 in Step S305. Further, the elevator monitoring device 20 displays the plurality of wear amount prediction values on the monitoring display.

Other configurations and a monitoring method in the seventh embodiment are the same as those in the first embodiment or the second embodiment.

Even with the configuration and the monitoring method described above, it is possible to more accurately predict the future wear amounts of the plurality of sheave grooves 8.

Further, the wear prediction unit 22 calculates the wear amount momentary values, and accumulates the wear amount momentary values, to thereby calculate the wear amount prediction values. Thus, it is possible to more accurately predict the future wear amounts of the plurality of sheave grooves 8.

Further, the wear prediction unit 22 updates the parameters of the wear prediction expression based on the past state quantity. Thus, it is possible to optimize the wear prediction expression for each elevator device 10, thereby being able to more accurately predict the future wear amounts of the plurality of sheave grooves 8.

An elevator monitoring program according to the seventh embodiment is a program for causing a computer to execute processing of the monitoring method by the elevator monitoring device 20 according to the seventh embodiment. Further, a recording medium according to the seventh embodiment is a computer-readable recording medium having recorded thereon the elevator monitoring program according to the seventh embodiment.

In the seventh embodiment, as the slippage amount to be input to the wear prediction expression, the slippage amount estimation value calculated through the slippage amount calculation expression described in the sixth embodiment may be used. In this case, the slippage amount calculation expression may be updated based on the past state quantity.

### Eighth Embodiment

Next, an elevator system in an eighth embodiment of this disclosure is described. A configuration of the elevator system in the eighth embodiment is the same as that of FIG. 1. Further, a control system of the elevator system in the eighth embodiment is the same as that of FIG. 6.

In the eighth embodiment, the momentary tension of the car-side portion of each of the plurality of ropes 5 is continuously measured by the first tension measurement device 12. Further, the momentary tension of the counterweight-side portion of each of the plurality of ropes 5 is continuously measured by the second tension measurement device 13.

The measurement results obtained by the first tension measurement device 12 and the second tension measurement device 13 are transmitted to the elevator monitoring device 20 via the maintenance device 30.

In the wear prediction unit 22, a tension model described later is stored. That is, the storage unit 24 stores the tension model. The wear prediction unit 22 uses tension analysis values as the tension of the car-side portion and the tension of the counterweight-side portion. The tension analysis values are calculated through use of the tension model.

The wear prediction unit 22 inputs, to the tension model, the measurement values obtained by the first tension measurement device 12 and the second tension measurement device 13, and the wear amount momentary values calculated similarly to the seventh embodiment. As a result, the wear prediction unit 22 calculates, as the tension analysis values, analysis values of the tension variation in each of the car-side portion and the counterweight-side portion when the car 1 makes a round travel between the lowest floor and the highest floor.

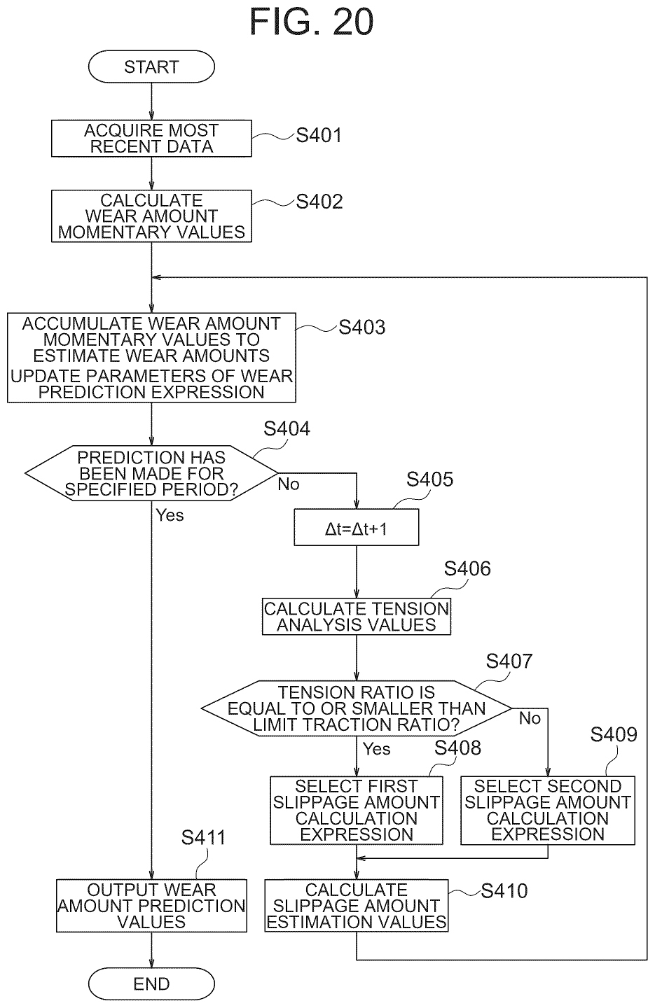

FIG. 20 is a flowchart for illustrating wear prediction processing by the elevator monitoring device 20 in the eighth embodiment. When the wear prediction processing is started, the elevator monitoring device 20 acquires the most recent data in Step S401. In the most recent data, the most recent tension data, the most recent rotation amount of the drive sheave 7, and the most recent travel distance of the car 1 are included.

Subsequently, the elevator monitoring device 20 calculates the wear amount momentary values through use of the wear prediction expression in Step S402.

After that, the elevator monitoring device 20 accumulates the wear amount momentary values to estimate the wear amounts in Step S403. Further, the elevator monitoring device 20 updates the parameters of the wear prediction expression through use of the past state quantity.

Subsequently, the elevator monitoring device 20 determines whether or not the wear amounts in the specified period have been calculated in Step S404.

When the wear amounts in the specified period have not been calculated, the elevator monitoring device 20 adds a time corresponding to one step to the period Δt in Step S405. Then, the elevator monitoring device 20 calculates the tension analysis values through use of the tension model in Step S406.

After that, the elevator monitoring device 20 determines whether or not the tension ratio is equal to or smaller than the limit traction ratio Γ in Step S407. When the tension ratio is equal to or smaller than the limit traction ratio T, that is, when the tension ratio does not exceed the limit traction ratio T, the elevator monitoring device 20 selects the first slippage amount calculation expression in Step S408.

When the tension ratio is not equal to or smaller than the limit traction ratio T, that is, when the tension ratio exceeds the limit traction ratio T, the elevator monitoring device 20 selects the second slippage amount calculation expression in Step S409.

After that, the elevator monitoring device 20 calculates the slippage amount estimation values through use of the first slippage amount calculation expression or the second slippage amount calculation expression in Step S410, and the process returns to Step S403.

In the processing step of Step S404, when the wear amounts in the specified period have been calculated, the elevator monitoring device 20 outputs the plurality of wear amount prediction values to the maintenance device 30 in Step S411. Further, the elevator monitoring device 20 displays the plurality of wear amount prediction values on the monitoring display.

As described above, the wear amount momentary value of each of the sheave grooves 8 is calculated for the period specified in advance, and the accumulation value of the wear amount momentary values is displayed as the wear amount prediction value of each sheave groove 8 on the maintenance display of the maintenance device 30.

Other configurations and a monitoring method in the eighth embodiment are the same as those in the seventh embodiment.

Even with the configuration and the monitoring method described above, it is possible to more accurately predict the future wear amounts of the plurality of sheave grooves 8.

Further, the wear prediction unit 22 uses the tension analysis values as the tension of the car-side portion and the tension of the counterweight-side portion. Thus, it is possible to more accurately predict the future wear amounts of the plurality of sheave grooves 8.

An elevator monitoring program according to the eighth embodiment is a program for causing a computer to execute processing of the monitoring method by the elevator monitoring device 20 according to the eighth embodiment. Further, a recording medium according to the eighth embodiment is a computer-readable recording medium having recorded thereon the elevator monitoring program according to the eighth embodiment.

The tension model used in the eighth embodiment is now described. The tension model is a model that is obtained by modeling each of the car-side portion and the counterweight-side portion as a spring and is formed of a plurality of motion equations.

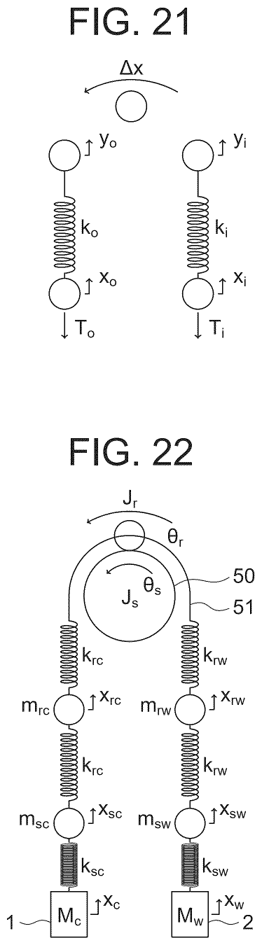

FIG. 21 is an explanatory diagram for illustrating the equivalent model of FIG. 15 separately in the winding-up-side portion and the feeding-out-side portion. In FIG. 21, the winding-up-side portion and the feeding-out-side portion are modeled as springs independent of each other. As a result, it is possible to consider a force balance condition for spring forces each determined from a displacement difference of both ends of each spring, that is, the tensions.

In FIG. 21, yi represents a displacement of an upper end of the winding-up-side portion. Further, yo represents a displacement of an upper end of the feeding-out-side portion. At a stationary time, that is, before the winding-up, a relational expression for the winding-up-side portion is given by the following expression.

$$Ti = ki ( yi - xi ) = ( EA / Li ) ( 0 - {x}^{′} i ) \qquad ( 1.3 )$$

In the relational expression, symbol ki is rope stiffness in the winding-up-side portion. Symbol yi is the displacement of the upper end of the winding-up-side portion. Symbol xi is a displacement of a lower end of the winding-up-side portion. Symbol Li is a length of the winding-up-side portion. Symbol E is Young's modulus of the rope model 51. Symbol A is a sectional area of a cross section forming the right angle with respect to a length direction of the rope model 51.

Further, symbol x′i is an initial stretch amount of the lower end of the winding-up-side portion, and has a negative value. A coordinate system in this case is defined such that a displacement in the upward direction is positive. The rope stiffness ki of the winding-up-side portion is a function of the Young's modulus E, the sectional area A, and the length Li of the winding-up-side portion.

The winding-up-side portion is to be wound by the pulley model 50 while the tension Ti is applied, and hence the following relational expression is obtained.

$$Ti = ( EA / Δ Li ) Δ ui \qquad ( 1.4 )$$

When the winding-up-side portion is minutely wound up by Δx on the pulley model 50, the lower end of the winding-up-side portion ascends by Δx as illustrated in FIG. 16 regardless of the rope stiffness. Thus, the force balance after the winding-up by Δx is given by the following expression.

$$Ti = ( EA / ( Li - Δ Li ) ) ( yi - xi ) = ( EA / ( Li - Δ Li ) ) \{ yi - ( {x}^{′} i + Δ x ) \} \qquad ( 1.5 )$$

The tension Ti of the winding-up-side portion is calculated from a displacement difference yi−xi between the upper end and the lower end of the winding-up-side portion. Further, from this expression, a relational expression which the displacement yi of the upper end of the winding-up-side portion is required to satisfy is obtained.

$$yi = ( Ti / EA ) ( Li - Δ Li ) + {x}^{′} i + Δ x \qquad ( 1.6 )$$

The following expression is obtained by rearranging the above-mentioned expression through use of Expression (1.1), Expression (1.3), and Expression (1.4).

$$yi = ( Ti / EA ) ( Li - Δ Li ) - ( Ti / EA ) Li + Δ Li + Δ ui = - ( Ti / EA ) Δ Li + Δ Li + Δ ui = - Δ ui + Δ Li + Δ ui = Δ Li \qquad ( 1.7 )$$

Thus, it is required to set the displacement yi of the upper end of the winding-up-side portion at the time of the minute winding-up not to the winding-up amount Δx, that is, not to ΔLi+Δui, but to the rope free length ΔLi of the winding-up amount Δx. As a result, the displacement xi of the lower end of the winding-up-side portion is the winding-up amount Δx.

Next, behaviors of two winding-up-side portions different from each other in applied tension are considered. In an actual elevator, the lower ends of two winding-up-side portions are connected to the car 1 or the counterweight 2, and hence the displacement amounts thereof are the same as each other. Thus, the lower end of the winding-up-side portion on which a tension Ti1 lower than a tension Ti2 is acting is pulled up more, and hence slack occurs, resulting in a decrease in tension. Further, the lower end of the winding-up-side portion on which the tension Ti2 is acting is pulled down, and hence the tension increases.

In the model used for this consideration, pulling-up amounts of the upper ends of the two winding-up-side portions are not uniformly Δx, but correspond to amounts of the rope free lengths ΔLi1 and ΔLi2 on the pulley model 50 in accordance with the tensions, and hence are different from each other. As a result of this correction made to the pulling-up amounts, both of the displacement amounts of the lower ends of the two winding-up-side portions are Δx.

Next, the feeding-out-side portion is described. From FIG. 21, a relational expression for the feeding-out-side portion at the stationary time is given as described below.

$$To = ko ( yo - xo ) = ( EA / Lo ) ( 0 - {x}^{′} o ) \qquad ( 1.8 )$$

In the relational expression, symbol ko is rope stiffness in the feeding-out-side portion. Symbol yo is the displacement of the upper end of the feeding-out-side portion. Symbol xo is a displacement of a lower end of the feeding-out-side portion. Symbol Lo is a length of the feeding-out-side portion. Symbol E is the Young's modulus of the rope model 51. Symbol A is the sectional area of the cross section forming the right angle with respect to the length direction of the rope model 51.

Further, symbol x′o is an initial stretch amount of the lower end of the feeding-out-side portion, and has a negative value. The rope stiffness ko of the feeding-out-side portion is a function of the Young's modulus E, the sectional area A, and the length Lo of the feeding-out-side portion.

When the winding-up-side portion is wound up by Δx, the feeding-out-side portion becomes longer by the rope free length ΔLi on the pulley model 50. Further, the rope free length ΔLi of the feeding-out-side portion is stretched by Δuo by the tension To of the feeding-out-side portion.

$$T o = ( EA / Δ Li ) Δ uo \qquad ( 1.9 )$$

Thus, when the rope model 51 is minutely wound up by Δx on the pulley model 50, the lower end of the feeding-out-side portion is displaced downward by ΔLi+Δuo. The force balance in the feeding-out-side portion after the winding-up by Δx is given by the following expression.

$$To = ( EA / ( Lo + Δ Li ) ) ( yo - xo ) = ( EA / ( Lo + Δ Li ) ) \{ yo - ( {x}^{′} o - Δ Li - Δ uo ) \} \qquad ( 1.1 )$$

The tension To of the feeding-out-side portion is calculated from a displacement difference yo−xo between the upper end and the lower end of the feeding-out-side portion. Further, from this expression, a relational expression which the displacement yo of the upper end of the feeding-out-side portion is required to satisfy is obtained.

$$y o = ( To / EA ) ( Lo + Δ Li ) + {x}^{′} o - Δ Li - Δ uo \qquad ( 1.11 )$$

The above-mentioned expression is rearranged through use of Expression (1.11), Expression (1.8), and Expression (1.9).

$$yo = ( To / EA ) ( Lo + Δ Li ) - ( To / EA ) Lo - Δ Li - Δ uo = ( To / EA ) Δ Li - Δ Li - Δ uo = Δ uo - Δ Li - Δ uo = - Δ Li \qquad ( 1.12 )$$

From this expression, it is required to set the displacement yo of the upper end given to the rope stiffness ko of the feeding-out-side portion not to the winding-up amount-Δx, but to the rope free length-ΔLi of the winding-up amount. As a result, the displacement xo of the lower end of the feeding-out-side portion is the feeding-out amount ΔLi+Δuo.

With respect to the displacement Δxi=ΔLi+Δui of the lower end of the winding-up-side portion, the displacement xo of the lower end of the feeding-out-side portion is ΔLi+Δuo. This difference is the creep amount Δcr of the rope model 51 on the pulley model 50.

$$Δ cr = Δ uo - Δ ui = ( Δ Li / EA ) ( To - Ti ) \qquad ( 1.13 )$$

As illustrated in FIG. 15, the consideration given above is formalization of the case in which the pulley model 50 rotates in the counterclockwise direction of FIG. 15. Meanwhile, when a relational expression in a case in which the pulley model 50 rotates in a clockwise direction of FIG. 15 is considered, the relational expression for the counterclockwise direction can be directly used by defining the winding-up amount Δx as a negative value. However, the tension of the winding-up-side portion is To of FIG. 15, and hence it is required to replace Ti of Expression (1.4) by To of FIG. 15.

Further, in FIG. 15, such a configuration that the rope model 51 is wound around an upper portion of the pulley model 50 and the rope model 51 is pulled downward is illustrated. However, the derived relational expression does not change even for such a configuration that the rope model 51 is wound around a lower portion of the pulley model 50 and the rope model 51 is pulled upward.

Based on the above-mentioned result, the winding model of the rope model 51 on the pulley model 50 can be rearranged as described below.
The counterclockwise rope displacement on the pulley model 50 is set to positive. The clockwise rope displacement on the pulley model 50 is set to negative. The sign of the winding-up amount Δx is set in accordance with the direction of the rotation.
The rope stiffness ki of the winding-up-side portion is defined as the value obtained by dividing a product of the Young's modulus E and the sectional area A of the rope model 51 by the length Li of the winding-up-side portion.
The rope stiffness ko of the feeding-out-side portion is defined as the value obtained by dividing a product of the Young's modulus E and the sectional area A of the rope model 51 by the length Lo of the feeding-out-side portion.
The lengths Li and Lo at the time of obtaining the rope stiffness ki and ko are set to the rope free lengths obtained when the tension is not acting on the rope model 51.
The tension Ti of the winding-up-side portion is defined as the value obtained by multiplying the rope stiffness ki by the displacement difference yi-xi between the upper end and the lower end.
The tension To of the feeding-out-side portion is defined as the value obtained by multiplying the rope stiffness ko by the displacement difference yo−xo between the upper end and the lower end.
The displacement of the end portion on the pulley model 50 side in the winding-up-side portion is defined as the value obtained by excluding the rope stretch amount Qui of the winding-up-side portion from the minute winding-up amount Δx of the rope model 51 on the pulley model 50, and corresponds to the rope free length ΔLi for the winding-up amount Δx.
The displacement of the end portion on the pulley model 50 side in the feeding-out-side portion is defined as the value obtained by excluding the rope stretch amount Qui of the winding-up-side portion from the minute winding-up amount Δx of the rope model 51 on the pulley model 50, and corresponds to the rope free length ΔLi for the winding-up amount Δx.
The rope stretch amount on the above-mentioned pulley model 50 is calculated from the tension Ti of the winding-up-side portion.

Next, FIG. 22 is an explanatory diagram for illustrating the elevator of FIG. 1 in a modeled manner. In FIG. 22, as the simplest model, a model of the 1:1 roping system in which the number of ropes of 1 is illustrated.

Each element of the elevator is modeled as a spring and a mass point. The rope 5 is modeled as a mass element on the drive sheave 7, and each of the winding-up portion side and the feeding-out portion side is modeled as a spring element.

In FIG. 22, symbol Js is a moment of inertia of the drive sheave 7. Symbol Jr is a moment of inertia of the rope 5 on the drive sheave 7. Symbol Jr is a moment of inertia caused by a mass of a portion of the rope 5 which moves integrally with the drive sheave 7.

Symbol Mc is a mass of the car 1. Symbol Mw is a mass of the counterweight 2. Symbol msc is a mass of a car-side shackle. Symbol msw is a mass of a counterweight-side shackle. In FIG. 1, illustration of the car-side shackle and the counterweight-side shackle is omitted.

Symbol mrc is a mass of the car-side portion in the rope 5. Symbol mrw is a mass of the counterweight-side portion in the rope 5. The car-side portion is the portion of the rope 5 positioned on the car 1 side with respect to the drive sheave 7. The counterweight-side portion is the portion of the rope 5 positioned on the counterweight 2 with respect to from the drive sheave 7. The above-mentioned parameters are parameters relating to inertial elements.

Symbol ksc is stiffness of the car-side shackle. Symbol ksw is stiffness of the counterweight-side shackle. Symbol krc is stiffness of the car-side portion in the rope 5. Symbol krw is stiffness of the counterweight-side portion in the rope 5. Those parameters are parameters relating to stiffness elements.

Symbol θs is a rotation angle of the drive sheave 7. Symbol θr is a rotation angle of the rope 5 on the drive sheave 7. Symbol xc is the displacement of the car 1. Symbol xw is the displacement of the counterweight 2. Symbol xsc is a displacement of the car-side shackle. Symbol xsw is a displacement of the counterweight-side shackle. Symbol xrc is a displacement of the car-side portion in the rope 5. Symbol xrw is a displacement of the counterweight-side portion in the rope 5.

A motion equation represented as a differential equation in which attenuation terms caused by attenuation elements are not considered is given below. As an operator indicating a second-order differentiation with respect to time t, d\hat{ }2/dt\hat{ }2 is used.

$$M c ( d \hat{} 2 / dt \hat{} 2 ) xc - ksc ( xsc - xc ) = - M c g \qquad ( 1.14 )$$

$$M w ( d \hat{} 2 / dt \hat{} 2 ) xw - ksw ( xsw - xw ) = - M w g \qquad ( 1.15 )$$

$$msc ( d \hat{} 2 / dt \hat{} 2 ) xsc + ksc ( xsc - xc ) - krc ( xrc - xsc ) = - msc g \qquad ( 1.16 )$$

$$msw ( d \hat{} 2 / dt \hat{} 2 ) xsw + ksw ( xsw - xw ) - krw ( xrw - xsw ) = - msw g \qquad ( 1.17 )$$

$$mrc ( d \hat{} 2 / dt \hat{} 2 ) xrc + krc ( xrc - xsc ) - krc ( - R 1 θ r - xrc ) = - mrc g \qquad ( 1.18 )$$

$$mrw ( d \hat{} 2 / dt \hat{} 2 ) xrw + krw ( xrw - xsw ) - krw ( - R 1 θ r - xrw ) = - mrw g \qquad ( 1.19 )$$

$$Js ( d \hat{} 2 / dt \hat{} 2 ) θ s = τ - λ \qquad ( 1.2 )$$

$$Jr ( d \hat{} 2 / dt \hat{} 2 ) θ r - krcR 1 ( - R 1 θ r - xrc ) + krwR 1 ( R 1 θ r - xrw ) = λ \qquad ( 1.21 )$$

Symbol R1 is a radius of the drive sheave 7. Symbol “g” is the gravitational acceleration. Symbol τ is a drive torque applied to the drive sheave 7. Symbol A is a restraining torque acting between the drive sheave 7 and the rope 5.

On the drive sheave 7, the drive sheave 7 and the rope 5 integrally move in a range of the limit traction ratio Γ. The limit traction ratio Γ is given as a function of a friction coefficient between the drive sheave 7 and the rope 5 and a winding angle of the rope 5 with respect to the drive sheave 7.

At this time, a condition satisfied by a ratio between the tension Ti of the winding-up-side portion and the tension To of the feeding-out-side portion in the rope 5, and a restraining condition expression are given by the following expressions. As an operator indicating a first-order differentiation with respect to time t, d/dt is used.

$$( 1 / Γ ) < ( To / Ti ) < Γ \qquad ( 1.22 )$$

$$( d / dt ) θ s - ( d / dt ) θ r = 0 \qquad ( 1.23 )$$

The restraining torque λ acts on the drive sheave 7 and the rope 5 as a force satisfying the above-mentioned expressions. Meanwhile, when the tension ratio To/Ti exceeds the limit traction ratio Γ, the rope 5 slips on the drive sheave 7 while the friction force is acting, and hence a difference occurs between a rotation speed of the drive sheave 7 and a rotation speed of the rope 5.

$$( d / dt ) θ s - ( d / dt ) θ r \neq 0 \qquad ( 1.24 )$$

Description is now given of a behavior exhibited when the car 1 descends, that is, the drive sheave 7 rotates in a counterclockwise direction of FIG. 22. A balanced state at a time t+Δt which changes from a balanced state at a time “t” after the minute time Δt has elapsed is considered. When the car 1 descends in the minute time Δt, the winding-up amount Δx on the drive sheave 7 is given by the following expression.

$$Δ x = R 1 Δθ r = Δ L + Δ u \qquad ( 1.25 )$$

In the expression, ΔL is the rope free length for the minute winding-up amount Δx at the time of the descent of the car 1, that is, the rope length in the state in which the tension is not acting. Further, Δu is the rope stretch amount for the minute winding-up amount Δx at the time of the descent of the car 1.

Each sheave groove 8 is ground by the rope 5 over time. The radius R1 is the radius of the drive sheave 7 in each sheave groove 8. Thus, when ground amounts in the plurality of sheave grooves 8 are different from one another, the radii R1 are minutely different from one another in accordance with the sheave grooves 8.

A difference among winding-up amounts occurs due to such a difference in radius R1, and hence a tension difference occurs among the plurality of ropes 5.

When the tension acting on the counterweight-side portion of the rope 5 is represented by Tw, Δu satisfies the following expression.

$$T w = ( EA / Δ L ) Δ u \to Δ u = ( Tw / EA ) Δ L \qquad ( 1.26 )$$

Thus, it is possible to obtain the rope free length ΔL from the minute winding-up amount Δx.

$$Δ x = ( 1 + ( Tw / ER ) ) Δ L \to Δ L = Δ x / ( 1 + ( Tw / EA ) ) \qquad ( 1.27 )$$

From this expression, a length Lc of the car-side portion of the rope 5 and a length Lw of the counterweight-side portion of the rope 5 are given by the following expressions.

$$Lo ( t + Δ t ) = Lc ( t + Δ t ) = Lc ( t ) + Δ L , \qquad ( 1.28 )$$

$$Li ( t + Δ t ) = L w ( t + Δ t ) = L w ( t ) - Δ L$$

A winding-up amount, a corresponding rope free length, and a rope stretch amount at the time t+Δt are given by the following expressions.

$$x ( t + Δ t ) = x ( t ) + Δ x , \qquad ( 1.29 )$$

$$L ( t + Δ t ) = L ( t ) + Δ L ,$$

$$u ( t + Δ t ) = u ( t ) + Δ u$$

An amount x(t+Δt)=Rθr(t+Δt) wound by the drive sheave 7 includes the rope stretch amount. However, in order to calculate the tension generated in the winding-up-side portion of the rope 5 and the tension generated in the feeding-out-side portion of the rope 5, Rθr is not directly used as the winding-up amount, but it is required to use the rope free length L.

The rope free length L can be obtained by the following expression.

$$x ( t + Δ t ) = R 1 θ r ( t + Δ t ) = L ( t + Δ t ) + u ( t + Δ t ) \to L = R 1 θ r - u \qquad ( 1.3 )$$

Thus, the tension Ti generated in the winding-up-side portion of the rope 5 is given by the following expression.

$$Ti = Tw = ki ( L - xrw ) = krw ( L - xrw ) = krw ( R 1 θ r - u - xrw ) \qquad ( 1.31 )$$

Further, the tension To generated in the feeding-out-side portion of the rope 5 is given by the following expression.

$$To = ko ( - L - x rc ) = kr c ( - L - x r c ) = k r c ( - R 1 θ r + u - xrc ) \qquad ( 1.32 )$$

From those expressions, the portion of the winding-up amount in the motion equations (1.18), (1.19), and (1.21) is corrected as given by the following expression.

$$R 1 θ r \to R 1 θ r - u \qquad ( 1.33 )$$

Next, description is given of a behavior exhibited when the car 1 ascends, that is, the drive sheave 7 rotates in a clockwise direction of FIG. 21. When the car 1 ascends in the minute time Δt, the winding-up amount Δx on the drive sheave 7 is given by the following expression. The counterclockwise direction of FIG. 21 is a positive direction. Thus, when the drive sheave 7 rotates in the clockwise direction of FIG. 21, the winding-up amount Δx is a negative value.

$$Δ x = R 1 θ r = Δ L + Δ u \qquad ( 1.34 )$$

In the expression, Δu is the rope stretch amount for the minute winding-up amount Δx at the time of the ascent of the car 1, and is a negative value.

When the tension acting on the car-side portion of the rope 5 is represented by Tc, Δu satisfies the following expression.

$$T c = ( EA / Δ L ) Δ u \to Δ u = ( Tc / EA ) Δ L \qquad ( 1.35 )$$

Thus, it is possible to obtain the rope free length ΔL from the minute winding-up amount Δx.

$$Δ x = ( 1 + ( Tc / EA ) ) Δ L \to Δ L = Δ x / ( 1 + ( Tc / EA ) ) \qquad ( 1.36 )$$

From this expression, the length Lc of the car-side portion of the rope 5 and the length Lw of the counterweight-side portion of the rope 5 are given by the following expressions.

$$L i ( t + Δ t ) = Lc ( t + Δ t ) = Lc ( t ) + Δ L , \qquad ( 1.37 )$$

$$Lo ( t + Δ t ) = L w ( t + Δ t ) = L w ( t ) - Δ L$$

The free length ΔL is a negative value. Thus, the rope length of the car-side portion decreases, and the rope length of the counterweight-side portion increases.

The rope free length L at the time of the ascent of the car 1 can be obtained by the following expression.

$$x ( t + Δ t ) = R 1 θ r ( t + Δ t ) = L ( t + Δ t ) + u ( t + Δ t ) \to L = R 1 θ r - u \qquad ( 1.38 )$$

Thus, the tension Ti generated in the winding-up-side portion of the rope 5 is given by the following expression.

$$Ti = T c = k i ( - L - x rc ) = kr c ( - L - x r c ) = k r c ( - R 1 θ r + u - xrc ) \qquad ( 1.39 )$$

Further, the tension To generated in the feeding-out-side portion of the rope 5 is given by the following expression.

$$To = ko = ( L - xrw ) = krw ( L - xrw ) = krw ( R 1 θ r - u - xrw ) \qquad ( 1.4 )$$

From those expressions, the portion of the winding-up amount in the motion equations (1.18), (1.19), and (1.21) is corrected as given by the following expression.

$$R 1 θ r \to R 1 θ r - u \qquad ( 1.41 )$$

From the above-mentioned results, the tension model as a generalized model of the rope winding-up can be defined as follows. In the specification and the appended claims, the analysis model relating to the rope tension is simplified, and hence is referred to as “tension model.”

Regardless of the direction of the travel of the car 1, the rope length Lc on the car 1 side and the rope length Lw on the counterweight 2 side are obtained by the following expressions. That is, the length of the winding-up-side portion and the length of the feeding-out-side portion are calculated from the rope free length ΔL.

$$L c ( t + Δ t ) = L c ( t ) + Δ L , Lw ( t + Δ t ) = L w ( t ) - Δ L \qquad ( 1.42 )$$

ΔL satisfies the following expression.

$$At time of car descent : Δ L = Expression ( 1.27 ) , \qquad ( 1.43 )$$

$$at time of car ascent : Δ L = Expression ( 1.36 )$$

The portion of the winding-up amount in the motion equations (1.18), (1.19), and (1.21) is corrected as given by the following expression.

$$R 1 θ r \to L = R 1 θ r - u \qquad ( 1.44 )$$

As expressed in Expression (1.27) and Expression (1.36), the rope free length ΔL is a function of the winding-up amount Δx and the tension Ti of the winding-up-side portion.

The relational expression in the minute time of the correction amount “u” is given by the following expression.

$$u ( t + Δ t ) = u ( t ) + Δ u \qquad ( 1.45 )$$

At time of car descent: Δu=Expression (1.26), at time of car ascent: Δu=Expression (1.35) (1.46)

As expressed in Expression (1.26) and Expression (1.35), the rope stretch amount Δu is a value proportional to the rope free length ΔL and the tension Ti of the winding-up-side portion.

The above-mentioned relational expressions are satisfied similarly even in the case in which one or more pulleys other than the drive sheave 7, which is a sheave, exist, and are satisfied regardless of the number of ropes 5.

Next, a calculation result in such a configuration that two ropes 5 are wound around the drive sheave 7 in the single-wrap configuration in an elevator of the 1:1 roping system is described as an example. In the following calculation, the tension of each of the two ropes 5 in each of a case in which the depths of the two sheave grooves 8 are equal to each other and a case in which the depths are different from each other is obtained while the car position is changed.

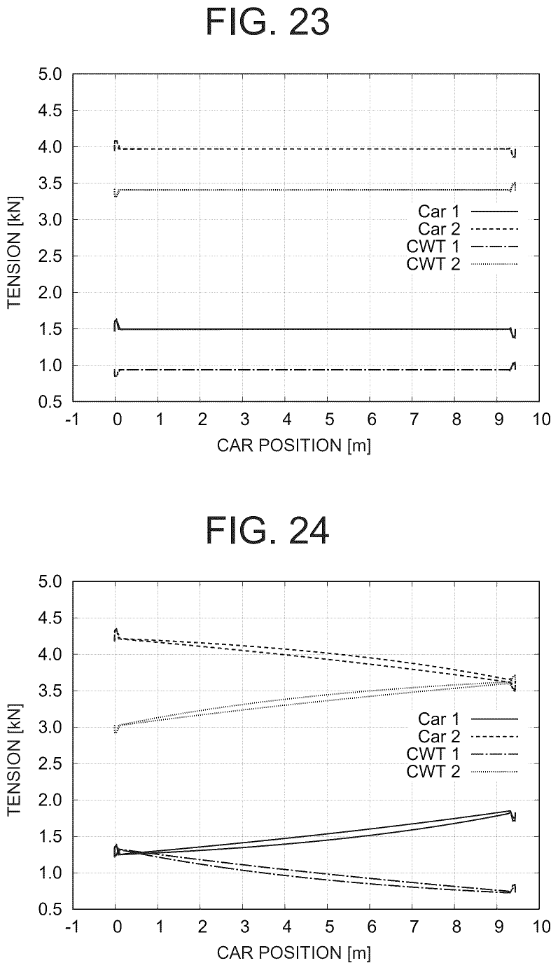

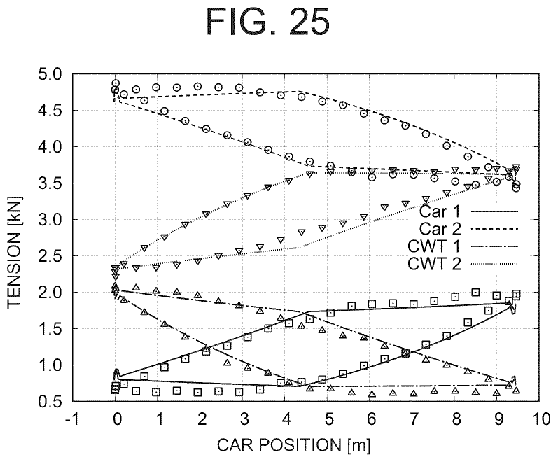

FIG. 23 is a graph for showing a relationship between the tensions of each of the two ropes 5 and the car position obtained when the depths of the two sheave grooves 8 are equal to each other. FIG. 24 is a graph for showing the relationship between the tensions of each of the two ropes 5 and the car position obtained when the depths of the two sheave grooves 8 are different from each other by 0.2 mm. FIG. 25 is a graph for showing a relationship between calculated values of the tension of each of the two ropes 5 and the car position in comparison with each of a plurality of actual measurement values obtained when the depths of the two sheave grooves 8 are different from each other by 0.7 mm.

In FIG. 23, FIG. 24, and FIG. 25, the car 1 makes the round travel from the highest floor to the lowest floor. Further, Car 1 indicates the tension of the car-side portion of one rope 5. Car 2 indicates the tension of the car-side portion of the other rope 5.

CWT 1 indicates the tension of the counterweight-side portion of the one rope 5. CWT 2 indicates the tension of the counterweight-side portion of the other rope 5. Further, the actual measurement value of each tension is a value obtained by measuring a tension acting on a shackle spring.

When the depths of the two sheave grooves 8 are equal to each other, the tensions show constant values regardless of the car positions as shown in FIG. 23.

Meanwhile, the difference in depth between the two sheave grooves 8 corresponds to a difference in radius R1 of the drive sheave 7 in the motion equation for each rope 5. When the depths of the two sheave grooves 8 are different from each other, the tensions at the time of the ascent of the car 1 and the tensions at the time of the descent present trajectories different from each other as shown in FIG. 24. In FIG. 24, the sheave groove 8 corresponding to Car 2 and CWT 2 is deeper than the sheave groove 8 corresponding to Car 1 and CWT 1.

When the winding-up amount is calculated through use of a model in which the rope stretch amount is not considered, even under a condition that the groove depth is the same, the tension changes in accordance with the change in car position due to existence of a difference in initial stretch amount of the rope representing deviation of an initial tension. Thus, a result different from the actual tension behavior in which the tension does not change in accordance with the car position is provided.

When a difference in depth between the two sheave grooves 8 increases, the tension ratio between the winding-up-side portion and the feeding-out-side portion exceeds the limit traction ratio T. Thus, the ropes 5 slip with respect to the drive sheave 7, and gradients of the tension variations change in the middle as shown in FIG. 25. From FIG. 25, it is understood that the tension variation including the rope slippage behavior can be accurately calculated through the analysis method in the first embodiment.

The limit traction ratio T is the function of the friction coefficient between the drive sheave 7 and the rope 5, and hence the limit traction ratio Γ also changes when the friction coefficient changes. This change in limit traction ratio Γ appears as a deviation of an inflection point at which the gradient of the tension variation changes. Thus, the variation amount of the friction coefficient can also be obtained by perceiving this deviation amount of the inflection point.

The tensions measured by the first tension measurement device 12 and the second tension measurement device 13 may be tensions measured while the car 1 is stopped at any appropriate position in a hoistway. With the elevator monitoring device 20 according to the eighth embodiment, it is possible to calculate, as the tension analysis value, the tension at a position other than the measurement position through use of the tension model.

Further, the tensions measured by the first tension measurement device 12 and the second tension measurement device 13 may be continuous tensions measured while the car 1 is traveling. In this case, a travel section of the car 1 may be the section from the lowest floor to the highest floor or a section between any appropriate two points.

Further, in the eighth embodiment, the first tension measurement device 12 and the second tension measurement device 13 may be sensors permanently installed or sensors mounted only at the time of the maintenance and inspection. In the elevator monitoring device 20 according to the eighth embodiment, the tension analysis value can be calculated by inputting, to the tension model, the information on the tensions measured at the time of the maintenance and inspection, the car travel distance, the car position, and the in-car load, and the plurality of wear amount prediction values can also be calculated.

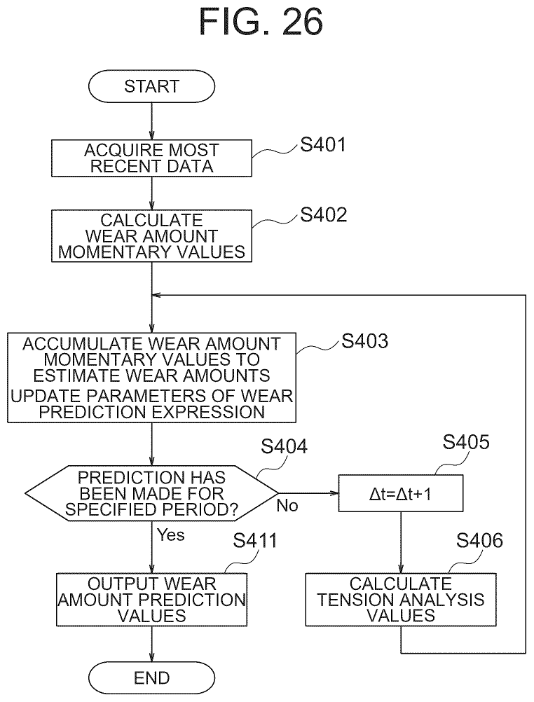

Further, FIG. 26 is a flowchart for illustrating wear prediction processing by the elevator monitoring device 20 in a modification example of the eighth embodiment. In this modification example, the processing steps of Step S407 to Step S410 of FIG. 20 are omitted.

In this way, the determination relating to the limit traction ratio Γ may be omitted.

Further, in the eighth embodiment, as in the sixth embodiment illustrated in FIG. 14, the rotation sensor 14 may be omitted. In this case, as in the sixth embodiment, the slippage amount estimation values are calculated.

### Ninth Embodiment

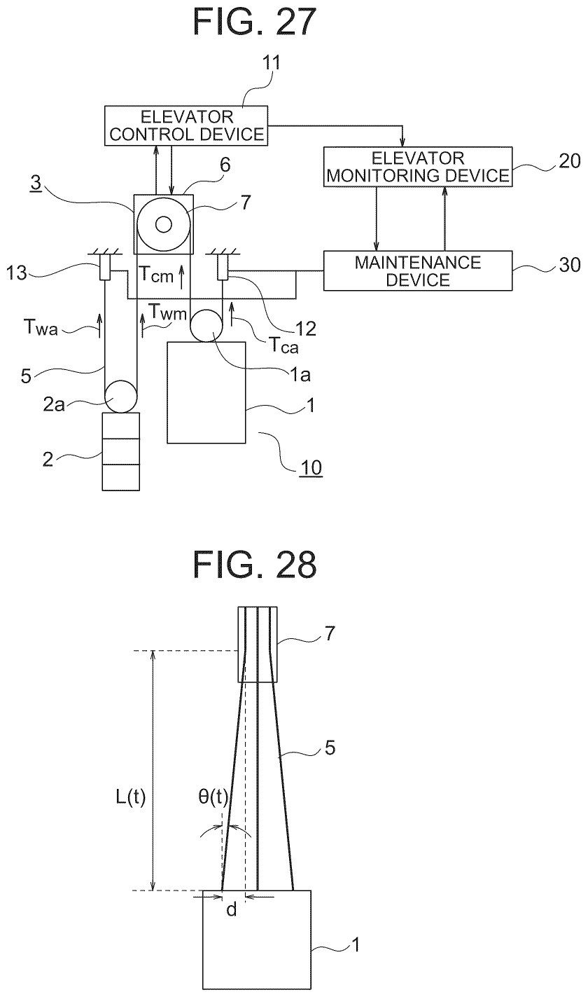

Next, FIG. 27 is a schematic configuration diagram for illustrating an elevator system in a ninth embodiment of this disclosure. The elevator device 10 in the ninth embodiment is a machine room-less elevator of a 2:1 roping system. The hoisting machine 3 is installed in a top portion of the hoistway. The elevator control device 11 is installed in the hoistway.

A car suspension sheave 1a, which is a sheave, is provided to the car 1. A counterweight suspension sheave 2a, which is a shave, is provided to the counterweight 2.

A car-side rope cleat (not shown) and a counterweight-side rope cleat (not shown) are installed in the top portion of the hoistway. A first end portion of each rope 5 is connected to the car-side rope cleat. A second end portion of each rope 5 is connected to the counterweight-side rope cleat.

Each rope 5 is wound around the car suspension sheave 1a, the drive sheave 7, and the counterweight suspension sheave 2a in the stated order from the first end portion side. The first tension measurement device 12 is provided in the first end portion. The second tension measurement device 13 is provided in the second end portion.

Each rope 5 includes a first portion, a second portion, a third portion, and a fourth portion. The first portion is a portion between the car-side rope cleat and the car suspension sheave 1a. The second portion is a portion between the car suspension sheave 1a and the drive sheave 7. The third portion is a portion between the drive sheave 7 and the counterweight suspension sheave 2a. The fourth portion is a portion between the counterweight suspension sheave 2a and the counterweight-side rope cleat.

On the first portion, a tension Tca acts by the weight of the car 1. On the second portion, a tension Tcm acts by the weight of the car 1. On the third portion, a tension Twm acts by the weight of the counterweight 2. On the fourth portion, a tension Twa acts by the weight of the counterweight 2.

The tension Tca is measured by the first tension measurement device 12. The tension Twa is measured by the second tension measurement device 13.

The tension Tcm and the tension Twm can be calculated as tension analysis values through use of the tension model. Further, the tension Tcm and the tension Twm may be measured through a percussion method or through use of a detachable sensor at the time of the maintenance and inspection.

A control system of the elevator system in the ninth embodiment is the same as that in the eighth embodiment. Further, a calculation method for the plurality of wear amount prediction values is the same as that in the eighth embodiment.

Even for the elevator device 10 of the 2:1 roping system described above, it is possible to more accurately predict the future wear amounts of the plurality of sheave grooves 8.

An elevator monitoring program according to the ninth embodiment is a program for causing a computer to execute processing of the monitoring method by the elevator monitoring device 20 according to the ninth embodiment. Further, a recording medium according to the ninth embodiment is a computer-readable recording medium having recorded thereon the elevator monitoring program according to the ninth embodiment.

### Tenth Embodiment

Next, a tenth embodiment of this disclosure is described. An elevator system in the tenth embodiment is the same as that of FIG. 1. Further, a control system of the elevator system in the tenth embodiment is the same as that of any one of the first embodiment to the eighth embodiment.

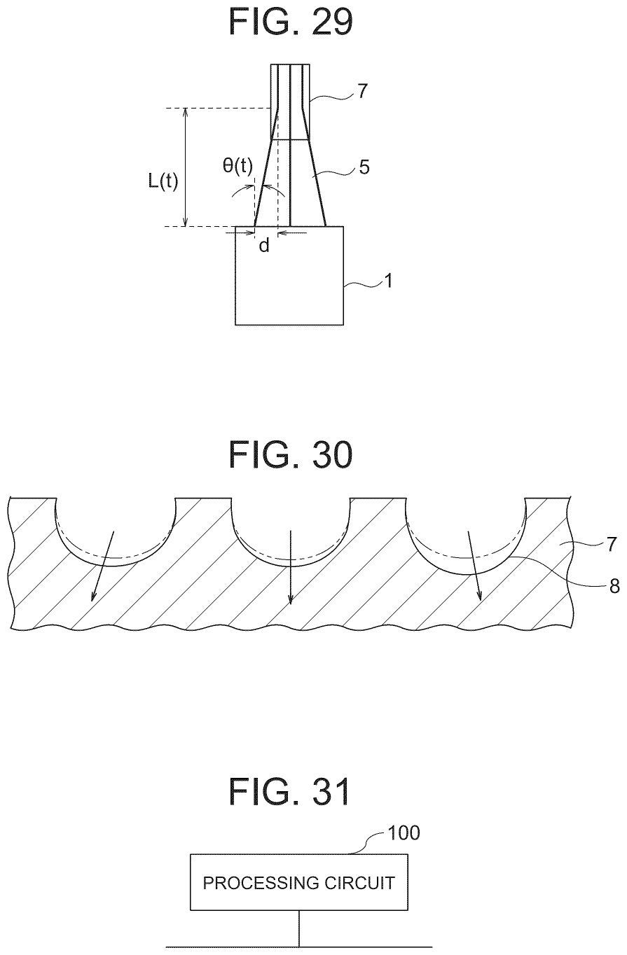

FIG. 28 is an explanatory diagram for schematically illustrating a relationship among the car 1, the drive sheave 7, and the plurality of ropes 5. FIG. 29 is an explanatory diagram for illustrating a state in which the car 1 of FIG. 28 has approached the drive sheave 7. In FIG. 28 and FIG. 29, three ropes 5 are illustrated as an example.

In the wear prediction unit 22 in the tenth embodiment, the following rope angle relational expression is stored. That is, the storage unit 24 stores the rope angle relational expression. The rope angle relational expression indicates a relationship among an angle θ(t) of the rope 5 with respect to the vertical direction, a vertical-direction distance L(t) from the drive sheave 7 to an end portion of the rope 5 on the car 1 side, and a deviation amount “d” of the end portion of the rope 5 on the car 1 side with respect to the sheave groove 8 in the horizontal direction. The angle θ(t) is also referred to as “fleet angle.”

$$θ ( t ) = {tan}^{- 1} ( d / L ( t ) )$$

A displacement of the car 1 in the horizontal direction is restricted by a pair of car guide rails (not shown), and hence the deviation amount “d” is a constant value independent of the car position. That is, the deviation amount “d” of FIG. 28 has the same value as that of the deviation amount “d” of FIG. 29.

Meanwhile, the distance L(t) and the angle θ(t) vary in accordance with the car position. When the car 1 moves from a lower floor to an upper floor, the value of the distance L(t) decreases, and the value of the angle θ(t) increases. Conversely, when the car 1 moves from an upper floor to a lower floor, the value of the distance L(t) increases, and the value of the angle θ(t) decreases.

The angle θ(t) varies in accordance with the car position, and hence a direction of the surface pressure acting on the sheave groove 8 also varies in accordance with the car position. When the direction of the surface pressure varies, a direction of the wear in the sheave groove 8 also varies. The angle θ(t) corresponds to a direction of progress of the wear.

FIG. 30 is a sectional view for illustrating an example of a wear state of each sheave groove 8 in the drive sheave 7 of FIG. 28. Each sheave groove 8 is worn from an initial state indicated by the two-dot chain line to a state indicated by the solid line. The progress direction of the wear in each sheave groove 8 is a direction indicated by the corresponding arrow.

The wear prediction unit 22 in the tenth embodiment applies the rope angle relational expression to the wear amount momentary value calculated by the wear prediction expression, to thereby estimate the direction of the progress of the wear. Further, the wear prediction unit 22 calculates the accumulation value of the wear amount momentary values in consideration of the angle θ(t) of the progress of the wear. Then, the wear prediction unit 22 outputs, to the maintenance device 30, a two-dimensional sectional shape, for example, as illustrated in FIG. 30, together with the plurality of wear amount prediction values.

In this case, the maintenance device 30 displays the two-dimensional sectional shape as illustrated in FIG. 30 on the maintenance display. Further, the elevator monitoring device 20 displays the two-dimensional sectional shape as illustrated in FIG. 30 on the monitoring display.

Configurations and a monitoring method in the tenth embodiment are the same as those in any one of the first embodiment to the ninth embodiment.

Even with the configuration described above, it is possible to more accurately predict the future wear amounts of the plurality of sheave grooves 8.

Further, the wear prediction unit 22 estimates the progress direction of future wear in the plurality of sheave grooves 8 through use of the rope angle relational expression. Thus, it is possible to more accurately predict the future wear state for each sheave groove 8.

An elevator monitoring program according to the tenth embodiment is a program for causing a computer to execute processing of the monitoring method by the elevator monitoring device 20 according to the tenth embodiment. Further, a recording medium according to the tenth embodiment is a computer-readable recording medium having recorded thereon the elevator monitoring program according to the tenth embodiment.

In the sixth embodiment to the tenth embodiment, one of the first tension measurement device 12 or the second tension measurement device 13 may be omitted. For example, when the second tension measurement device 13 is omitted, the tension of the counterweight-side portion can be calculated from a design value of the weight of the counterweight 2.

Further, in the sixth embodiment to the tenth embodiment, the measurement data from the first tension measurement device 12 and the second tension measurement device 13 may be transmitted to the elevator monitoring device 20 via the elevator control device 11 without an intermediation of the maintenance device 30.

Further, in the sixth embodiment to the tenth embodiment, the measurement data from the first tension measurement device 12 and the second tension measurement device 13 may be directly transmitted to the elevator monitoring device 20 without an intermediation of the maintenance device 30.

Further, in the seventh embodiment to the tenth embodiment, the signal from the rotation sensor 14 may be directly transmitted to the elevator monitoring device 20 without an intermediation of the elevator control device 11.

Further, the rope in this disclosure is a rope in a broad sense, and includes, for example, a belt which suspends the car.

Further, the sheave in this disclosure is not limited to the drive sheave 7.

Further, the elevator device in this disclosure may be, for example, an elevator including a machine room, a machine room-less elevator, a double-deck elevator, and a one-shaft multi-car system elevator. The one-shaft multi-car system is a system in which an upper car and a lower car arranged directly below the upper car are vertically moved in the common hoistway independently.

Further, in the first embodiment to the tenth embodiment, the elevator monitoring device 20 may be an independent device or may be built into another device as some of the functions of the another device. Examples of the another device include the maintenance device 30 and the elevator control device 11.

Further, the elevator monitoring device 20 may be implemented on a cloud, a server, or the like on a communication network.

Further, each of the functions of the elevator monitoring device 20 according to the first embodiment to the tenth embodiment is implemented by a processing circuit. FIG. 31 is a configuration diagram for illustrating a first example of the processing circuit for implementing each of the functions of the elevator monitoring device 20 according to the first embodiment to the tenth embodiment. A processing circuit 100 of the first example is dedicated hardware.

Further, the processing circuit 100 corresponds to, for example, a single circuit, a complex circuit, a programmed processor, a processor for a parallel program, an application specific integrated circuit (ASIC), a field programmable gate array (FPGA), or a combination thereof. Further, the respective functions of the elevator monitoring device 20 may be implemented by individual processing circuits 100, or the functions may be collectively implemented by the processing circuit 100.

Further, FIG. 32 is a configuration diagram for illustrating a second example of the processing circuit for implementing each of the functions of the elevator monitoring device 20 according to the first embodiment to the tenth embodiment. A processing circuit 200 of the second example includes a processor 201 and a memory 202.

As the processor for example, a central processing unit (CPU), a graphics processing unit (GPU), a microprocessor, a microcontroller, or a digital signal processor (DSP) is used.

In the processing circuit 200, each of the functions of the elevator monitoring device 20 is implemented by software, firmware, or a combination of software and firmware. The software and the firmware are described as programs to be stored in the memory 202. The processor 201 reads out and executes the programs stored in the memory 202, to thereby implement the respective functions.

The programs stored in the memory 202 can also be regarded as programs for causing a computer to execute the procedure or method of each of the above-mentioned units. In this case, the memory 202 corresponds to, for example, a nonvolatile or volatile semiconductor memory, such as a random access memory (RAM), a read only memory (ROM), a flash memory, an erasable programmable read only memory (EPROM), or an electrically erasable and programmable read only memory (EEPROM). Further, a magnetic disk, a flexible disk, an optical disc, a compact disc, a MiniDisc, a DVD, or the like also corresponds to the memory 202.

The function of each of the above-mentioned units may be implemented partially by dedicated hardware, and partially by software or firmware.

In this way, the processing circuit can implement the function of each of the above-mentioned units by hardware, software, firmware, or a combination thereof.

What is claimed is:

1. An elevator monitoring device, comprising a wear prediction circuitry configured to calculate a wear amount prediction value being a prediction value of a future wear amount that occurs in a set period in each of a plurality of sheave grooves through use of a wear prediction expression which uses, as inputs, a tension of a car-side portion and a tension of a counterweight-side portion in each of a plurality of ropes suspending a car and a counterweight, a slippage amount of each of the plurality of ropes, and material hardness of a sheave.

2. The elevator monitoring device according to claim 1, wherein the wear prediction circuitry is configured to:
acquire an average value of the tension of the car-side portion and an average value of the tension of the counterweight-side portion in each of the plurality of ropes;
calculate a surface pressure acting on each of the plurality of sheave grooves; and
calculate the wear amount prediction value for each of the plurality of sheave grooves.

3. The elevator monitoring device according to claim 1, wherein the wear prediction circuitry is configured to acquire an average value of average tensions of all car-side portions in the plurality of ropes and an average value of average tensions of all counterweight-side portions in the plurality of ropes.

4. The elevator monitoring device according to claim 2, wherein each of the average values includes a tension variation caused by movement of the car.

5. The elevator monitoring device according to claim 1, wherein the wear prediction circuitry is configured to:
calculate surface pressures acting on the plurality of sheave grooves through use of the tensions of the plurality of ropes in the wear prediction expression; and
calculate a creep amount as the slippage amount from a difference between a rotation amount of the sheave and a travel distance of the car.

6. The elevator monitoring device according to claim 1,
wherein the wear prediction circuitry stores a slippage amount calculation expression, and
wherein the wear prediction circuitry is configured to use, as the slippage amount, a slippage amount estimation value calculated through use of the slippage amount calculation expression.

7. The elevator monitoring device according to claim 6,
wherein the wear prediction circuitry stores a first slippage amount calculation expression and a second slippage amount calculation expression as the slippage amount calculation expression, and
wherein the wear prediction circuitry is configured to determine which of the first slippage amount calculation expression and the second slippage amount calculation expression is to be selected in accordance with whether a ratio between the tension of the car-side portion and the tension of the counterweight-side portion exceeds a limit traction ratio.

8. The elevator monitoring device according to claim 1, wherein the wear prediction circuitry is configured to input momentary tension data as the tension of the car-side portion and the tension of the counterweight-side portion to the wear prediction expression, calculate a wear amount momentary value of each of the plurality of sheave grooves, and accumulate the wear amount momentary value, to thereby calculate the wear amount prediction value.

9. The elevator monitoring device according to claim 1, wherein the wear prediction circuitry is configured to update a parameter of the wear prediction expression based on a past state quantity including past tension data, a past rotation amount of the sheave, and a past wear amount.

10. The elevator monitoring device according to claim 1,
wherein the wear prediction circuitry is configured to use a tension analysis value calculated through use of a tension model as each of the tension of the car-side portion and the tension of the counterweight-side portion, and
wherein the tension model is a model that is obtained by modeling each of the car-side portion and the counterweight-side portion as a spring and is formed of a plurality of motion equations.

11. The elevator monitoring device according to claim 1,
wherein the wear prediction circuitry stores a rope angle relational expression by which an angle of each of the plurality of ropes that varies in accordance with a car position is to be obtained, and
wherein the wear prediction circuitry is configured to estimate a progress direction of future wear in each of the plurality of sheave grooves through use of the rope angle relational expression.

12. An elevator monitoring method, comprising a wear prediction step of calculating a wear amount prediction value being a prediction value of a future wear amount that occurs in a set period in each of a plurality of sheave grooves through use of a wear prediction expression which uses, as inputs, a tension of a car-side portion and a tension of a counterweight-side portion in each of a plurality of ropes suspending a car and a counterweight, a slippage amount of each of the plurality of ropes, and material hardness of a sheave.

13. A recording medium having recorded thereon an elevator monitoring program for causing a computer to execute the elevator monitoring method of claim 12.
